(19) United States
(12) Patent Application Publication
(10) Pub. No.: US 2011/0186405 A1
(43) Pub. Date: Aug. 4, 2011

(54) METHODS, APPARATUSES, AND SYSTEMS FOR CONVEYING AND SORTING PRODUCE

(75) Inventors: Philippe BLANC, Montauban (FR); Francois BAREILLE, Montauban (FR)

(73) Assignee: MAF Industries, Inc., Traver, CA (US)

(21) Appl. No.: 12/699,373

(22) Filed: Feb. 3, 2010

(51) Int. Cl. B65G 47/244; B65G 43/10; B65G 47/90; H04N 7/18

(52) U.S. Cl. 198/413; 198/575; 198/867.02; 348/86; 348/E07.085

(57) ABSTRACT

Systems for conveying and sorting can include a plurality of clamps, a loading conveyor, an introduction screw, a sizing conveyor, and a plurality of outlet conveyor. Some systems can further include a weighing station, and imaging station, and a computer. A clamping apparatus can include an engagement block with a milling for slidable engagement with a chain, a nipple for engagement within a helical slot of a screw, and an opening for receiving a distal end of an elongate finger. The clamping apparatus can further include an elongate securing member for removably hanging a product there from. Imaging systems can include a rotation block, a gear wheel rotably coupled with the rotation block, a driving member, and at least one camera.

### BACKGROUND OF THE INVENTION

1. Field of the Invention

The present invention generally relates to the field of food processing. More specifically, embodiments of the present invention pertain to methods, apparatuses, and systems for conveying, sizing, sorting, and packaging stemmed produce, such as bunches of grapes and truss tomatoes.

2. Background and Description of Related Art

Many types of agricultural crops, such as bunches of grapes and truss tomatoes, are harvested, packaged into individual bags or containers, and then boxed for sale to consumers. Generally, the monetary value of these commercial units is determined by both by the grade of the crop as well as the net weight of the package and/or box.

In some conventional processes, after the crop is harvested from the plant, field workers assess its quality by visually inspecting, among other things, the coloring and shape of the crop. Crop of different quality is sorted into one of a plurality of different grade lines and poor quality crop may be discarded. The crop may then be weighed, individually or collectively, at a packaging station to determine whether a given package (or a box having a plurality of packages) has insufficient or excess weight relative to a desired minimum net weight of the package. If the weight is insufficient, workers add additional crop until the weight exceeds the desired minimum net weight. If the weight is in excess of the minimum net weight, workers may either remove some of the crop from the package or simply disregard the overage. In many cases, this results in overpacked boxes since it is far easier and more time efficient to overpack boxes than to achieve a specific weight target.

A significant disadvantage to this conventional process is the unnecessary labor costs involved in the weighing, modifying, and reweighing step. Another disadvantage is that the total weight of the packages can be inconsistent among similarly graded and marked packages. Furthermore, crop that has been assessed and packaged by human field workers has an appreciable percentage of overpackaging which leads to a loss of earnings for the packer and/or producer.

In an attempt to overcome these disadvantages, mechanized sorting and packaging systems have been developed which result in more uniform grading and packaging. For example, U.S. Pat. No. 6,957,940 discloses a unit for sorting and packaging products that includes a conveying line having an endless chain, a plurality of work stations, and an optical analysis station. A plurality of coupling arms, each articulated with the endless chain, are engaged with hooking members for hanging the products therefrom. The single, synchronous conveying line transports the product through the work stations and optical analysis station.

It is to be appreciated that the throughput of automated sorting and packaging systems having a single, synchronous conveying line is limited, in part, by the speed at which workers load and unload products. For instance, the rate at which product is placed on the conveyor at the plurality of loading stations may be different than the rate at which product is removed from the conveyor at the plurality of unloading stations. In some conventional approaches, when product is not removed from the conveyor at the unloading stations fast enough, the entire conveying line must be slowed down or brought to a complete stop to allow the workers to catch up. On the other hand, when product is not placed on the conveyor fast enough at the loading stations, workers at the unloading station may sit idle with nothing to package. At the same time, various sorting and grading mechanisms within the system, including weighing stations and optical analysis stations, are electrically and computationally more efficient when a constant or nearly constant number of products are being weighed and/or imaged during a given period. Thus, some conventional systems require the numbers and efficiencies of workers at each the loading and unloading stations, and the speed at which the conveying line operates, to be constantly monitored to ensure adequate throughput.

U.S. Pat. No. 6,957,940 also discloses that the optical analysis station can include sensors, such as cameras, arranged on both sides of the conveyor so as to view four equatorial faces of the products. It can be appreciated however that, in some applications, it may be preferred to provide the sensors on a single side of the conveyor and rotate the product as it is being imaged by the sensors. For example, different imaging methods may require a plurality of surface images, with or without overlapping portions, to be taken of the product. In other examples, some imaging methods, such as x-ray and/or metal detection, may require that the product to be imaged is located between an emitter and a receiver. Unfortunately, conventional automated sorting and packaging systems lack features for rotating the product through an imaging section of a conveyor.

It is therefore desirable to provide systems for sorting and packaging products wherein the loading, unloading, conveying, imaging, and weighing occur asynchronously such that the products to be sorted and packaged may enter in accumulation on a main sizing conveyor and may exit the main sizing conveyor in accumulation onto one or more unloading conveyors. It is further desirable to provide systems for sorting and packaging wherein the product that is loaded onto the main sizing conveyor may rotate through an imaging portion of the system to obtain images from all sides of the product.

### SUMMARY OF THE INVENTION

Embodiments of the present invention relate to methods, apparatuses, and systems for conveying, sizing, sorting, and packaging stemmed produce, such as bunches of grapes and truss tomatoes. In advantageous embodiments, the produce can be transported along one or more asynchronous conveying devices throughout the sorting and packaging process. In other advantageous embodiments, a plurality of sides of the produce can be imaged by rotating the produce as it moves along the conveyor.

In some aspects, the invention concerns a system that can include: a plurality of clamps, each clamp comprising (i) an engagement block comprising a milling, a nipple, and an opening and (ii) an elongate securing member extending from the engagement block for removably clamping a product hanging therefrom; a loading conveyor comprising a first endless chain for conveying the plurality of clamps from at least one loading station to a first transfer location, wherein the first endless chain has a top portion for slidable engagement with the millings of the clamps; an introduction screw and guide for conveying the plurality of clamps from the first transfer location to a second transfer location, wherein the introduction screw has an outside surface comprising a helical slot for engagement with the nipples of the clamps and wherein the guide has a top portion for slidable engagement with the millings of the clamps; a sizing conveyor comprising a second endless chain for selectively conveying the plurality of clamps from the second transfer location to one of a plurality of unloading locations, wherein the second endless chain has a plurality of hooks engaged therewith, each of the hooks comprising an elongate finger having a distal end for insertion into the opening of one of the clamps; and a plurality of outlet conveyors each comprising an endless chain for conveying the plurality of clamps from the unloading locations to at least one unloading station, wherein each chain of the outlet conveyor has a top portion for slidable engagement with the millings of the clamps.

In some embodiments, a transfer portion of the sizing conveyor may be parallel and adjacent to a transfer portion of the introduction screw, and the distal ends of elongate fingers of the hooks on the transfer portion of the sizing conveyor may be aligned with the openings of the clamps on the transfer portion of the introduction screw.

In some embodiments, the helical slot may have a pitch that varies along a length of the introduction screw. In some embodiments, the pitch may be greatest at a location between the first transfer location and the second transfer location. In some embodiments, the pitch at the first transfer location may be less than the pitch at the second transfer location. In some embodiments, the pitch at the first transfer location may be equal to a width of the engagement block of the clamp. In some embodiments, the pitch at the second transfer location may be equal to a distance between adjacent hooks on the sizing conveyor.

In some embodiments, each of the hooks may include: a fork joint comprising at least two tines, wherein the elongate finger may be pivotly engaged with the fork joint about a first axis; a hooking pin extending from a side of the elongate finger, wherein the hooking pin is parallel with the first axis; and a spring-loaded locking pin extending between the tines of the fork joint, wherein the locking pin is parallel with the first axis. In some embodiments, the locking pin may include a first portion having a first diameter and a second portion having a second diameter greater than the first diameter, and the elongate finger includes a proximal end having a first notch corresponding to the first portion of the locking pin and a second notch corresponding to the second portion of the locking pin.

In some embodiments, each of the hooks may have an unlocked position when the first notch of the elongate finger is engaged with the first portion of the locking pin and a locked position when the second notch of the elongate finger is engaged with the second portion of the locking pin. In some embodiments, the system may include a hooking ramp at the second transfer location having a sloped upper face for contacting the hooking pins and pivoting the elongate fingers until the hooks are in the locked position. In some embodiments, the system may include, at each of the unloading locations, an unhooking cam having a sloped side face for contacting distal ends of the locking pins and moving the locking pins inwardly until the second notches of the elongate fingers are disengaged with the second portions of the locking pins. In some embodiments, the system may include, at each of the unloading locations, an unhooking ramp having a sloped upper face for contacting the hooking pins and pivoting the elongate fingers until the hooks are in the unlocked position.

In some embodiments, the system may include a scale at the second transfer location for weighing the product hanging from each clamp. In some embodiments, the system may include an endless chain having a top portion for slidable engagement with the millings of the clamps.

In some embodiments, the system may include at least one camera for imaging the product hanging from each clamp. In some embodiments, each of the hooks may include: a rotation block fixedly engaged with the sizing chain, the rotation block comprising a spring-loaded locking pin and a locking trigger extending from the locking pin; and a gear wheel operatively engaged with the elongate finger and rotatably engaged with the rotation block, the gear wheel comprising a locking hole for receiving a distal end of the locking pin of the rotation block. In some embodiments, the system may include a driving member corresponding to the gear wheels of the hooks for asynchronously rotating the gear wheels with respect to the sizing chain. In some embodiments, the driving member may be a chain or a belt. In some embodiments, the system may include a plow for raising and holding the locking trigger to cause the distal end of the locking pins of the rotation blocks to dislocate from the locking holes of the gear wheels.

In some aspects, the invention concerns a system for sizing and packing a product. The system can include: a clamp comprising (i) an engagement block comprising a milling, a nipple, and an opening and (ii) an elongate securing member extending from the engagement block for removably clamping the product hanging therefrom; a loading conveyor having a first endless chain with a top portion for slidable engagement with the milling of the clamp; a sizing conveyor having a second endless chain with a hook engaged therewith, the hook comprising an elongate finger with a distal end for insertion into the opening of the clamp; an introduction screw having an outside surface comprising a helical slot with a variable pitch for engagement with the nipple of the clamp, wherein the introduction screw aligns the opening of the clamp with the elongate finger of the hook; an outlet conveyor comprising a third endless chain having a top portion for slidable engagement with the milling of the clamp; a weighing station for determining the weight of the product; an imaging station for imaging the product; and a computer in communication with the weighing station and the imaging station.

In some embodiments, the hook can include: a fork joint comprising at least two tines, wherein the elongate finger is pivotly engaged with the fork joint about a first axis; a hooking pin extending from a side of the elongate finger, wherein the hooking pin is parallel with the first axis; a first spring-loaded locking pin extending between the tines of the fork joint, the locking pin comprising a first portion having a first diameter and a second portion having a second diameter greater than the first diameter, wherein the locking pin is parallel with the first axis, the locking pin; a rotation block fixedly engaged with the sizing chain, the rotation block comprising a second spring-loaded locking pin and a locking trigger extending from the locking pin; and a gear wheel fixedly engaged with the fork joint and rotatably engaged with the rotation block about a second axis, the second axis perpendicular to the first axis, the gear wheel comprising a locking hole for receiving a distal end of the second locking pin.

In some embodiments, the system may include a hooking ramp having a sloped upper face adjacent to a path of the hooking pin of the hook on the sizing conveyor, wherein an upward force is applied to the hooking pin causing the distal end of the elongate finger to pivot upwardly until a notch in a proximal end of the elongate finger is engaged with the second portion of the first locking pin. In some embodiments, the system may include a unhooking cam and an unhooking ramp, the unhooking cam in communication with the computer and having a sloped side face for contacting a distal end of the first locking pin of the hook as the hook is moving on the sizing conveyor, wherein an inward force is applied to the first locking pin causing the first locking pin to move inwardly until a notch in a proximal end of the elongate finger is disengaged with the second portion of the first locking pin. In some embodiments, the system may include an unhooking ramp having a sloped upper face for contacting the hooking pin of the hook as the hook is moving on the sizing conveyor after the unhooking cam has applied the inward force to the first locking pin.

In some embodiments, the imaging station can include a driving member for engagement with the gear wheel of the hook and for causing the gear wheel to rotate about the second axis while the hook is moving on the sizing conveyor. In some embodiments, the driving member may be a chain or a belt. In some embodiments, the imaging station may include at least one camera for capturing at least one image of the product as the product rotates about the second axis. In some embodiments, the imaging station may include a plow for lifting and holding the locking trigger as the gear wheel is rotating about the second axis.

In some aspects, the invention concerns a method for sorting and packaging a harvested agricultural crop that can include the steps of: at a loading station, temporarily attaching a distal end of a clamp to a stem of the crop and slidably engaging a milling of the clamp with a first endless chain; moving the first endless chain to transport the clamp to a first end of an introduction screw; engaging a nipple of the clamp with a helical slot on an outside surface of the introduction screw and rotating the introduction screw to transport the clamp from the first end of the introduction screw to a second end of the introduction screw; discharging the clamp from the second end of the introduction screw onto a weighing station and determining a weight of the clamp and the crop attached thereto; inserting a distal end of an elongate finger of a hook engaged with a second endless chain through an opening of the clamp and moving the second endless chain to transport the clamp to a discharge location; slidably engaging the milling of the clamp with a third endless chain and moving the third endless chain to transport the clamp to an unloading station; and at the unloading station, disengaging the clamp from the third endless chain and detaching the distal end of the clamp from the stem of the crop.

In some embodiments, the method may include the step of slidably engaging the milling of the clamp with a guide, the guide located adjacent to and parallel with a portion of the introduction screw.

In some embodiments, the weighing station can include a scale and a fourth endless chain, and the method may include the step of slidably engaging the milling of the clamp with the fourth endless chain and moving the fourth endless chain to transport the clamp onto the scale.

In some embodiments, the method can include the step of capturing at least one image of the crop as the clamp is transported to the unloading station. In some embodiments, the hook may include a gear wheel engaged with the elongate finger and rotably engaged with a rotation block engaged with the chain, and the method can include the step of rotating the gear wheel while capturing the at least one image. In some embodiments, the method can include the step of engaging the gear wheel with a driving member, the driving member having a portion about parallel to a portion of the second endless chain. In some embodiments, the driving member can be a chain or a belt.

In some embodiments, the method can include the step of at least partially inserting a distal end of the elongate finger in the opening of the clamp at a location between the first and the second end of the introduction screw.

In some embodiments, the elongate finger may be hingedly engaged about a first axis with a joint of the hook, the elongate finger having a hooking pin extending therefrom and parallel to the first axis, and the method may include the step of applying an upward force to the hooking pin to lift the elongate finger upwardly into a locked position. In some embodiments, the elongate finger may be hingedly engaged about a first axis with a joint of the hook, the joint having a spring-loaded locking pin disposed therein and parallel to the first axis for engaging with a proximal end of the elongate finger, and the method may include the step of applying an inward force to the locking pin to disengage the proximal end of the elongate finger from the locking pin.

In some aspects, the invention concerns a clamp for conveying a product along each of a chain, a hook with an elongate finger, and an introduction screw with a helical slot on an outside surface thereof. The clamp can include: an engagement block comprising a top portion having a front face and a back face, a bottom portion, and at least two side portions; a milling associated with the bottom portion of the engagement block, the milling having a first inner sidewall and a second inner sidewall defining an elongate channel with a width corresponding to a width of the chain; a nipple extending about perpendicularly from one of the side portions of the engagement block, the nipple having a diameter corresponding to a diameter of the helical slot of the introduction screw; an opening associated with the top portion of the engagement block, the opening defining at least a partial cavity in one of the group consisting of the front face, the back face, and combinations thereof, the opening having a dimension corresponding to a dimension of the elongate finger of the hook; and an elongate securing member comprising at least two about parallel rods, each rod having a distal end and extending downwardly from at least one of the side portions of the engagement block, the securing member having a closed position wherein a compressive force is applied to a portion of the product disposed between the distal ends of the parallel rods.

In some embodiments, the elongate securing member may include a handle hingedly engaged with a strap surrounding the rods, the handle having a position corresponding to the closed position of the securing member.

In some embodiments, each distal end of the parallel rods may include a portion perpendicular to a main portion of the rod. In some embodiments, each distal end of the parallel rods may include one of the group consisting of silicon, rubber, a compressible material, and combinations thereof.

In some embodiments, two about parallel rods can be included, wherein the rods may be unitarily joined at proximal ends thereof.

In some embodiments, the engagement block may include two side portions, wherein the nipple extends from a first side portion and each rod extending downwardly from a second side portion.

In some embodiments, each of the milling, the nipple, and the opening may be integrally formed in the engagement block.

In some embodiments, the engagement block may include a substantially T-shape, the top portion having a length about less than a length of the milling.

In some embodiments, the opening may be integrally formed in the top portion of the engagement block, the opening defining a substantially U-shaped channel extending from the front face to the back face. In some embodiments, at least one cross member may be disposed at a top of the U-shaped channel.

In some aspects, the invention concerns a system for imaging a product temporarily hanging from a clamp. The system may include: a rotation block comprising a housing having a top portion fixedly engaged with a conveyor, a spring-loaded locking pin, and a locking trigger fixedly engaged with the locking pin; a gear wheel having a bottom surface operatively engaged with the clamp, a top surface having at least one locking hole for receiving a distal end of the locking pin, and a plurality of teeth at a circumferential edge; a driving member about parallel to an imaging section of the conveyor, the driving member comprising one of the group consisting of a belt, a chain, and combinations thereof, the driving member having a plurality of engaging features on a surface thereof corresponding to the teeth of the gear wheel; a rotation pin axially disposed along a central axis of the gear wheel for rotational coupling of the gear wheel and one of the group consisting of the conveyor, the rotation block, and combinations thereof; and at least one camera proximally disposed to the imaging portion of the conveyor, each camera configured to capture an image of the produce as the produces moves along the conveyor.

In some embodiments, the gear wheel may have a fixed position relative to the rotation block when the distal end of the locking pin is engaged in the locking hole. In some embodiments, the gear wheel may rotate around the central axis when the distal end of the locking pin is engaged in the locking hole. In some embodiments, the gear wheel may rotate around the central axis when the engaging features of the driving member are engaged with the teeth of the gear wheel.

In some embodiments, a plow may be disposed parallel to the imaging portion of the conveyor, the plow may have a sloped upper surface for slidably contacting a lower surface of the locking trigger.

In some embodiments, the system may include N number of cameras, the conveyor may move at a speed of A, and the circumferential edge of the gear wheel may have a length L. In some embodiments, the cameras may be evenly spaced along a length X of the imaging section of the conveyor, each camera oriented about perpendicularly to a direction of travel of the conveyor. In some embodiments, the cameras may be positioned on a single side of the conveyor. In some embodiments, the driving member may move at a speed of L times A divided by X. In some embodiments, at least one of the cameras may be oriented at an angle of between 30 and 150 degrees relative to a direction of travel of the conveyor. In some embodiments, the gear wheel may rotate between 180 degrees and 540 degrees through the imaging section of the conveyor.

By providing a system whereby product to be sorted and packaged (i) enters in accumulation to the sorting portion of the machine and (ii) exits in accumulation from the sorting portion of the machine, an increase in throughput and a reduction in labor costs can be achieved. By providing for means to rotate the product in front of a plurality of imaging sensors, the product can imaged on a plurality of sides without the need to stop the product in front of each imaging sensor.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a plan view diagram illustrating an exemplary system in accordance with some embodiments of the present invention.

FIG. 2 is an elevational view diagram illustrating an exemplary system in accordance with some embodiments of the present invention.

FIGS. 3A and 3B are front perspective views illustrating an exemplary clamp in open and closed positions, respectively, in accordance with some embodiments of the present invention.

FIG. 3C is a rear perspective view illustrating the exemplary clamp of FIG. 3B in accordance with some embodiments of the present invention.

FIG. 3D is a front view illustrating the exemplary clamp of FIG. 3B in accordance with some embodiments of the present invention.

FIG. 3E is a side view illustrating the exemplary clamp of FIG. 3B in accordance with some embodiments of the present invention.

FIG. 4 is an illustration of an exemplary loading station in accordance with some embodiments of the present invention.

FIG. 5 is a front view illustrating an exemplary clamp having a milling engaged with a chain in accordance with some embodiments of the present invention.

FIGS. 6A and 6B are front and rear perspective views, respectively, illustrating an exemplary introduction screw in accordance with some embodiments of the present invention.

FIG. 7 is a plan view diagram illustrating an exemplary introduction screw and sizing conveyor in accordance with some embodiments of the present invention.

FIG. 8 is a perspective view illustrating an exemplary clamp having an opening engaged with an exemplary hook in accordance with some embodiments of the present invention.

FIGS. 9A and 9B are side and front views, respectively, illustrating an exemplary hook in a closed position in accordance with some embodiments of the present invention.

FIGS. 10A and 10B are side and front views, respectively, illustrating an exemplary hook in an open position in accordance with some embodiments of the present invention.

FIG. 11 is a side view illustrating an exemplary weighing station and an exemplary hooking ramp in accordance with some embodiments of the present invention.

FIG. 12 is a perspective view illustrating an exemplary hook in accordance with some embodiments of the present invention.

FIGS. 13A and 13B are front views illustrating an exemplary hook in locked and unlocked positions, respectively, in accordance with some embodiments of the present invention.

FIGS. 14A and 14B are plan view diagrams illustrating exemplary imaging stations in accordance with some embodiments of the present invention.

FIG. 15 is a perspective view illustrating a portion of an exemplary imaging station in accordance with some embodiments of the present invention.

FIG. 16 is a plan view diagram illustrating exemplary unloading locations in accordance with some embodiments of the present invention.

FIG. 17 is a perspective view illustrating an exemplary unloading location in accordance with some embodiments of the present invention.

FIGS. 18A and 18B are rear views illustrating exemplary unloading locations in open and closed positions, respectively, in accordance with some embodiments of the present invention.

FIG. 19 is an illustration of an exemplary unloading station in accordance with some embodiments of the present invention.

FIG. 20 is a side view illustrating an exemplary unloading station in accordance with some embodiments of the present invention.

### DETAILED DESCRIPTION OF THE PREFERRED EMBODIMENTS

The invention, in its various aspects, will be explained in greater detail below. While the invention will be described in conjunction with several exemplary embodiments, the exemplary embodiments themselves do not limit the scope of the invention. Similarly, the exemplary embodiments as illustrated in the accompanying drawings do not limit the scope of the exemplary embodiments and/or invention. Rather the invention, as defined by the claims, may cover alternatives, modifications, and/or equivalents of the exemplary embodiments.

It is to be appreciated that although the invention is described in conjunction with methods, apparatuses, and systems for conveying, sizing, sorting, and/or packaging stemmed produce, several embodiments of the present invention also contemplate conveying, sizing, sorting, and/or packaging other items. For example, and without limitation, some aspects of the invention may be practiced to convey and size non-produce items which may be hung from a clamp. It is also to be appreciated that although the invention may sometimes be described in conjunction with reference to chains and/or belts for conveying the advantageous clamps and/or hooks as described herein, it is to be appreciated that embodiments of the invention also contemplate other conveying means, such as for example, and without limitation, cables. It is further to be appreciated that although the invention may sometimes be described with reference to a single conveying means operable through one or more portions of the system, such as a single conveying chain, some aspects of the invention also contemplate a plurality of operationally engaged conveying means. Likewise, although the invention may sometimes be described with reference to a plurality of conveying means, some aspects of the invention also contemplate a single conveying means.

Exemplary Sizing Systems

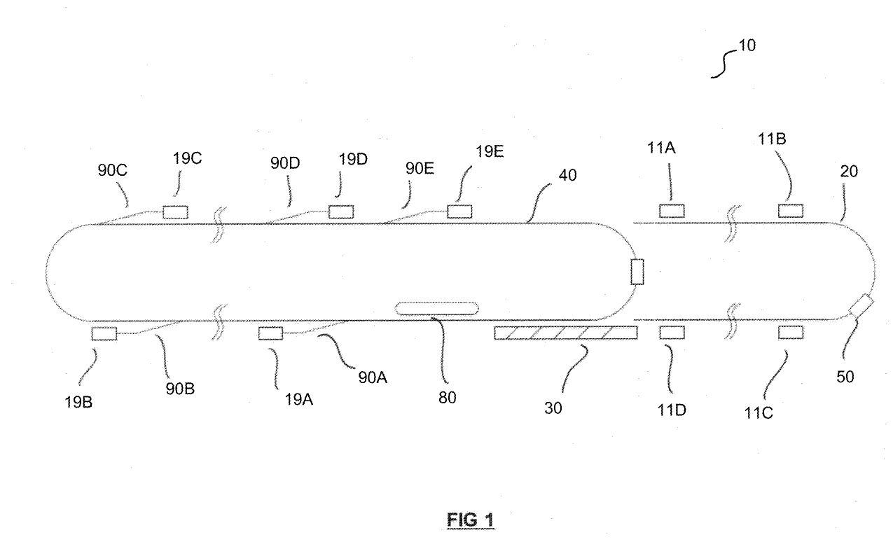

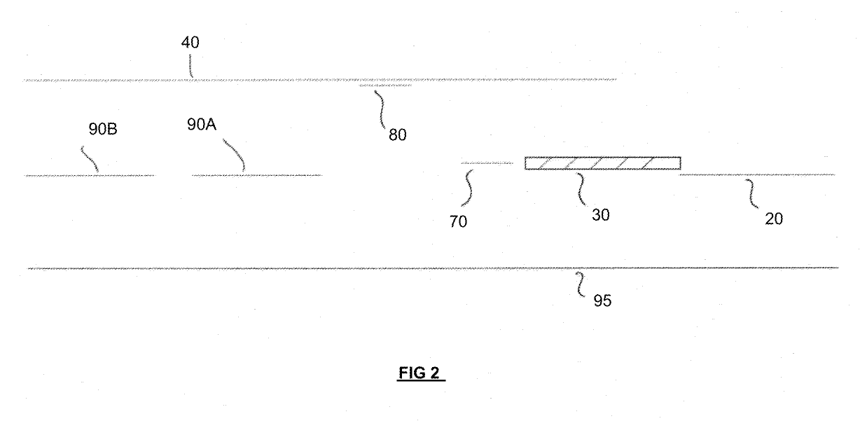

Referring now to the exemplary illustrations of FIGS. 1 and 2, in advantageous embodiments, systems for conveying, sizing, sorting, and packaging stemmed produce, such as bunches of grapes and truss tomatoes can have a plurality of loading stations 11A-11D disposed around a portion of a loading conveyor 20. In some embodiments, loading conveyor 20 may comprise at least one endless chain having a plurality of interconnected links. For example, and without limitation, loading conveyor 20 can comprise a roller chain having a plurality of plates held together by sleeves or bushings. The sleeves or bushings may cooperate with at least one sprocket (not shown) having teeth for transmitting motion thereto. In some examples, loading conveyor 20 can comprise a block chain having a plurality of plates held together by blocks. In some embodiments, loading conveyor 20 may comprise one or more ropes, cables, or belts cooperating with a rotating drum or other driving means. It is to be appreciated that other conveying means are contemplated in accordance with some embodiments of the present invention.

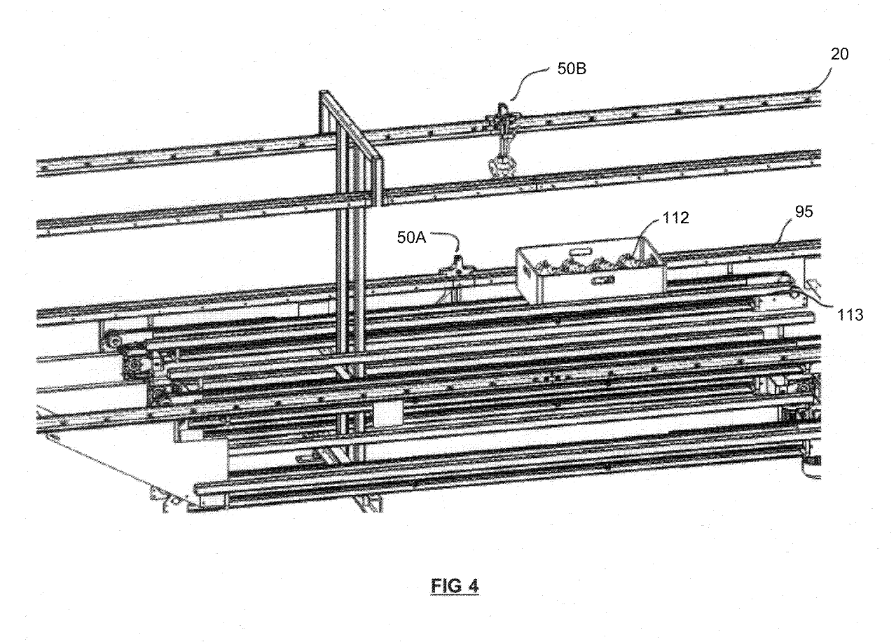

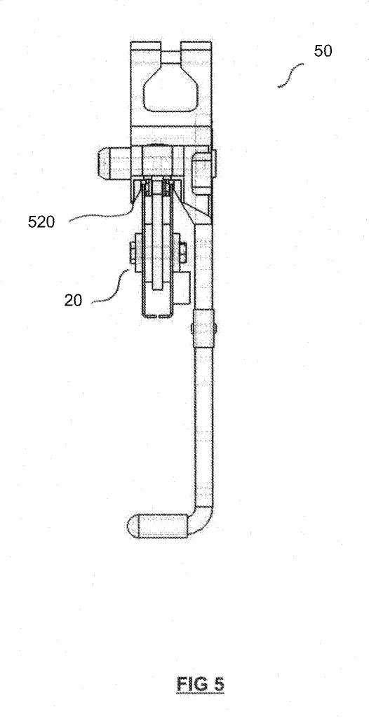

At each of the plurality of loading stations 11A-11D, the produce may be removably attached to clamps allowing the produce to hang therefrom. As illustrated in FIG. 4, in some examples, and without limitation, a container 112 of bulk produce may be transported to the loading station by bulk conveying means 113. A plurality of clamps having no produce attached thereto, such as clamp 50A, may similarly be transported to the loading station by return conveyor 95, discussed more fully below. A worker may first remove a clamp (such as clamp 50A) from return conveyor 95 and remove a piece of produce from container 112. As discussed more fully below, in some embodiments, the clamps may have an elongate clamping or pinching member having a lower end for compressibly engaging with a stalk of the produce. After the produce has been attached to the clamp, the clamp may then be engaged with loading conveyor 20. For example, and without limitation, clamp 50B having produce attached thereto may be hung on loading conveyor 20 at one of the loading stations 11A-11D. As illustrated in FIG. 5, in some embodiments, and discussed more fully below, clamp 50 may have a milling 520 for slidable engagement with a top portion of a chain of loading conveyor 20. It is to be appreciated however, that other means of slidably engaging the clamp with the loading conveyor are contemplated in accordance with some embodiments of the present invention.

Referring back to the examples of FIGS. 1 and 2, in some embodiments, loading conveyor 20 may be configured to transport clamp 50 to a first transfer location. For example, and without limitation, loading conveyor 20 may transport clamp 50 to a first end of an introduction screw 30. In some advantageous embodiments, and discussed more fully below, introduction screw 30 may include a helical slot having a non-uniform pitch for receiving a complementary structure of clamp 50. For example, and without limitation, clamp 50 may have a nipple extending therefrom for engagement within a helical slot of introduction screw 30.

In some advantageous embodiments, loading conveyor 20 may operate asynchronously from introduction screw 30 such that the clamps may accumulate on loading conveyor 20 at the first transfer location. For example, and without limitation, the milling of clamp 50 may provide for slidable engagement with conveyor 20 such that a plurality of clamps accumulate at an end of introduction screw 30. Advantageously, the rates at which the clamps are placed and/or conveyed on loading conveyor 20 may be disassociated from the rates at which the clamps enter into and/or are conveyed through introduction screw 30. It is to be appreciated that a slot having a variable pitch provides a variable rate at which clamp 50 is conveyed through introduction screw 30. For example, and without limitation, the speed at which clamp 50 is conveyed through the first end of introduction screw 30 may be about equal to the speed at which clamp 50 is conveyed through loading conveyor 20 while the speeds at which clamp 50 is conveyed through other portions of the introduction screw may be different.

In some embodiments, and as discussed more fully below, introduction screw 30 facilitates the transfer of the clamps to sizing conveyor 40. In some embodiments, sizing conveyor 40 includes a plurality of hooks, such as hook 60, for capturing clamp 50 and transporting clamp 50 through weighing, imaging, and/or sorting stations. As illustrated in the example of FIG. 2, in some embodiments, a portion of sizing conveyor 40 may disposed parallel and vertically offset from an operational plane of loading conveyor 20 and/or introduction screw 30. In some examples, and without limitation, a plurality of hooks engaged with the sizing conveyor (for example, and without limitation, hook 60 of FIG. 1) may extend below the sizing conveyor. In some embodiments, and discussed more fully below, the clamps may have openings in a top portion thereof and the hooks may have elongate fingers for insertion in the openings of the clamps. Thus, as the clamps are moved through the introduction screw, the non-uniform pitch of the introduction screw may cause the elongate fingers of the hooks to become aligned with and inserted into the openings of the hooks. Thereafter, the clamps may be transferred from the introduction screw and transported along the sizing conveyor.

In some embodiments, the produce attached to clamp 50 may be weighed at a weighing station disposed at a second end of introduction screw 30. In some embodiments, the weighing station may include weighing conveyor 70 for transporting clamp 50 across a scale (not shown). In some embodiments, clamp 50 may thereafter be fully secured on hook 60 and transported through an imaging station. In some embodiments, the produce can be rotated through the imaging station for enabling image capturing on all sides of the produce. Thus, in some embodiments, and discussed more fully below, hook 60 may include features for engaging with an imaging chain or belt 80 to cause clamp 50 to rotate along a central axis while clamp 50 is simultaneously being conveyed along sizing conveyor 40.

In some embodiments, after the produce has been weighed and imaged, a computing means such as a computer can associate with each clamp on the sizing conveyor one or more metrics corresponding to the measured weight from the scale and spectral data from the images. For example, and without limitation, the produce can be graded by weight, density, color, and geometry. In some examples, and without limitation, the produce can be bunches of grapes, and the computing means can associate metric(s) with the clamp corresponding to the weight of the bunch, the size and variation thereof of the elements of a bunch, and the coloration and variations thereof of the bunch.

In some embodiments, the computing means may allocate a clamp to one of a plurality of unloading stations depending on the metrics. For example, and without limitation, a plurality of unloading stations 19A-19E may be located around sizing conveyor 40. In some embodiments, a plurality of outlet conveyors 90A-90E are disposed between a portion of sizing conveyor 40 and unloading stations 19A-19E, respectively. In some embodiments, as the clamps move along sizing conveyor 40 via the hooks, they may be allocated to and discharged on one of the outlet conveyors 90A-90E depending on the computed metrics. For example, and without limitation, those clamps having bunches of grapes with a weight within a first range may be discharged to outlet conveyor 90A while those clamps having bunches of grapes with a weight within a second range may be discharged to outlet conveyor 90B. In some embodiments, each unloading station may be associated with a specific packaging weight or grade. In other embodiments, the computing means may dynamically allocate the produce on a cumulative basis. For example, and without limitation, the computing means may allocate clamps to an unloading station such that the total weight of all produce allocated thereto in a given period is about equal to a minimum pack weight. Similarly, all produce having a “premium” grade may be allocated to a first unloading station while produce having other grades may be allocated to other unloading stations.

In some embodiments, some clamps may be allocated to other discharge paths (not shown). For example, and without limitation, clamps having poorly graded produce (for example, and without limitation, produce having rot, fungus, or invasive insects) may be allocated to a refuse path. In some other examples, and without limitation, wherein the computing means has allocated a clamp to a unloading station but that particular unloading station is unable to receive any additional clamps (for example, and without limitation, because the unloading station is full), the clamp can be discharged back onto loading conveyor 20.

In some embodiments, each outlet conveyor may include a chain, rope, cable, or belt for conveying the clamp away from sizing conveyor 40 to one of the unloading stations. In some embodiments, and similar to loading conveyor 20, each outlet conveyor 90A-90E may include a chain with a top portion for slidable engagement with a milling of the clamps. In other embodiments, outlet conveyor may include a guide, such as a rail, for slidable engagement with the milling of the clamps. However, it is to be appreciated that other means of conveying the clamps from sizing conveyor 40 to unloading stations 19A-19E are contemplated in accordance with some embodiments of the present invention.

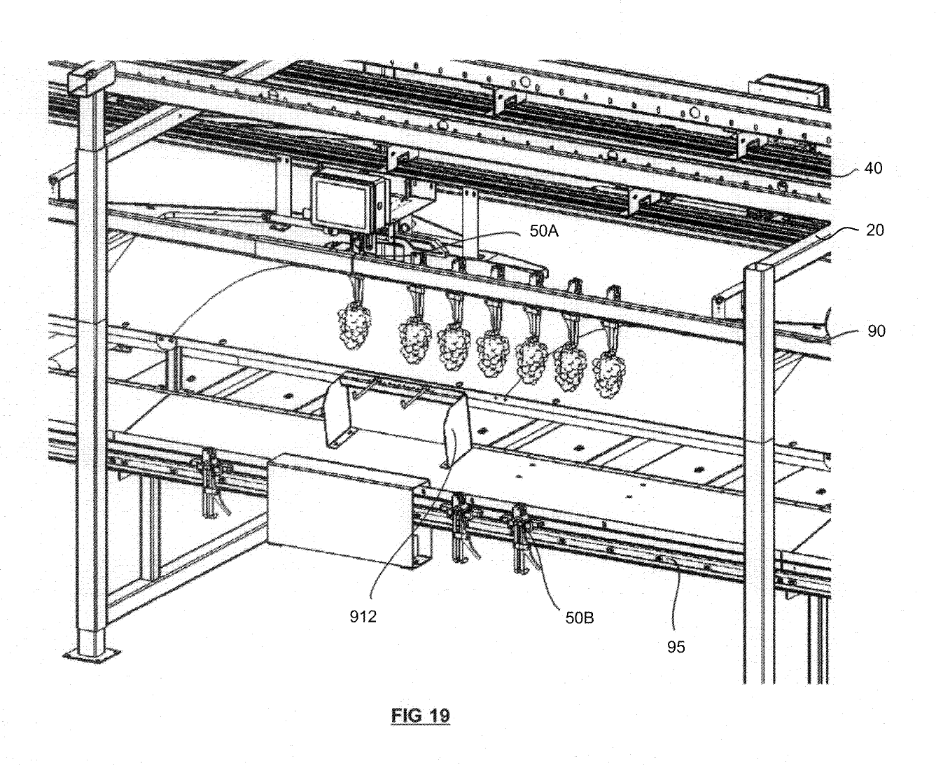

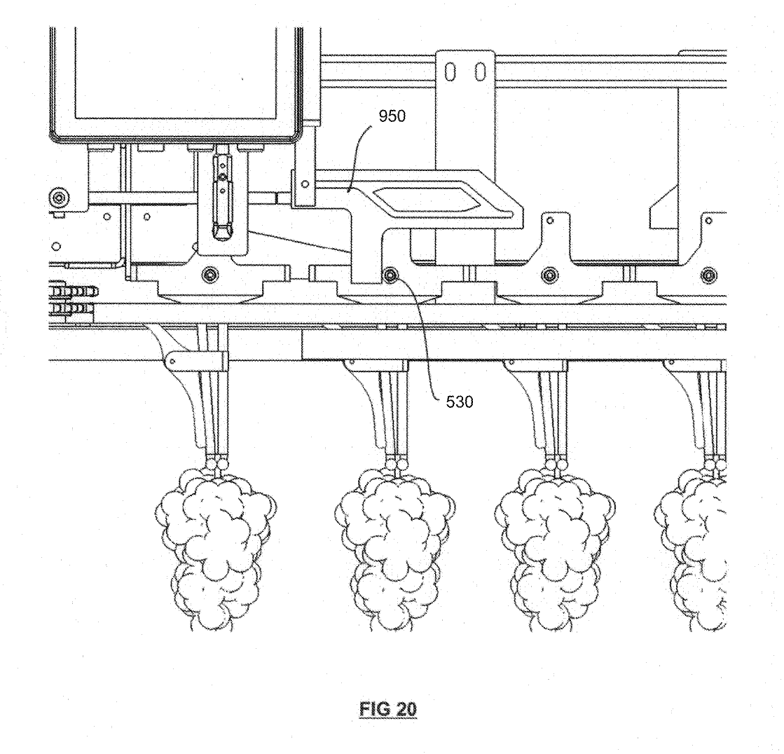

At each of the plurality of unloading stations 19A-19E, the produce may be removed from the clamps and packaged into individual bags and/or boxes. As illustrated in FIG. 19, in some examples, and without limitation, at each of the plurality of unloading stations 19A-19E, clamp 50A may first be removed from outlet conveyor 90. The produce may then be detached from clamp 50A and placed into individual bags and/or boxes 912. Once the produce has been removed from the clamp, the clamp (such as clamp 50B) may be placed on a return conveyor 95 for transportation back to one of the plurality of loading stations 11A-11D. In some embodiments, and referring to the example of FIG. 20, means may be provided at a terminal end of an outlet conveyor for restraining movement of the clamps as additional clamps accumulate on the outlet conveyor. In some embodiments, a hold-off or indexer may be provided for contact with a portion of the engagement block of one of the clamps in accumulation. For example, and without limitation, indexer 950 may have an elongate member for contacting nipple 530 of the second clamp in accumulation on the outlet conveyor. After the first clamp has been removed at a removal location, indexer 950 may be moved in an upwards direction to allow the second clamp to move forward to the removal location. It is to be appreciated that other indexing means are contemplated in accordance with some embodiments of the present invention.

It is to be appreciated that by dissociating the loading conveyor and the sizing conveyor, the rate at which clamps are loaded onto the system may be independent of the rate at which the clamps are transported though the sizing and sorting operations. For example, and without limitation, the clamps having produce attached thereto may be placed onto loading conveyor 20 at a rate of between 20-30 clamps per minute while sizing conveyor 40 can size and convey the produce at a fixed rate of 25 clamps per minute. For any given period of time, when the rate at which the clamps are placed on loading conveyor 20 exceeds the rate at which sizing conveyor 40 operates, the clamps may accumulate at the first end of introduction screw 30.

Similarly, it is to be appreciated that by disassociating the sizing conveyor from the outlet conveyors, the rate at which clamps are transported through the sizing and sorting operations may be independent of the rate at which the clamps are removed from the outlet conveyors. For example, and without limitation, sizing conveyor 40 can size and convey the produce at a fixed rate of 25 clamps per minute while the clamps can be removed from outlet conveyors 90A-90E at unloading stations 19A-19E at a rate of between 15-30 clamps per minute. For any given period of time, when the rate at which the clamps are removed from outlet conveyors 90A-90E is less than the rate at which sizing conveyor 40 operates, the clamps may accumulate on an given outlet conveyor. In addition, if it is not possible for additional clamps to accumulate on a given outlet conveyor (because, for example and without limitation, the outlet conveyor is at maximum capacity), the clamp may be loaded back onto loading conveyor 20. Therefore, some systems in accordance with advantageous embodiments of the present invention provide for asynchronous loading, sorting, and unloading operations.

Exemplary Clamps

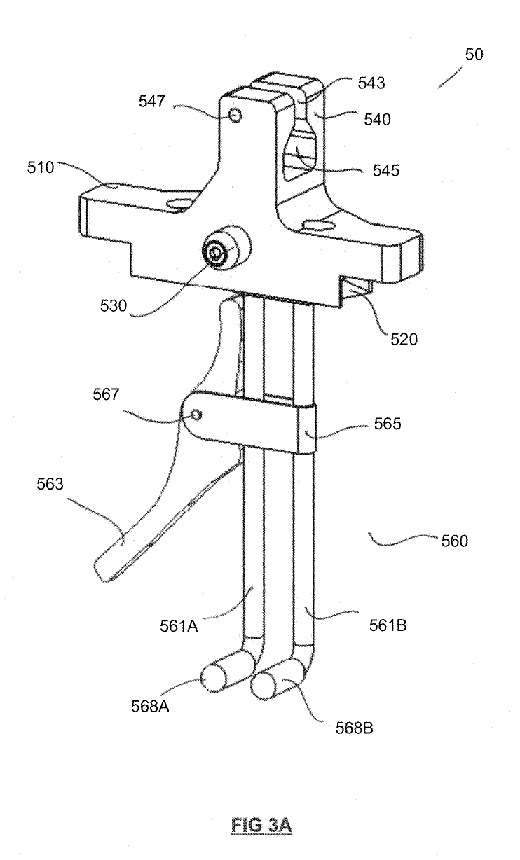

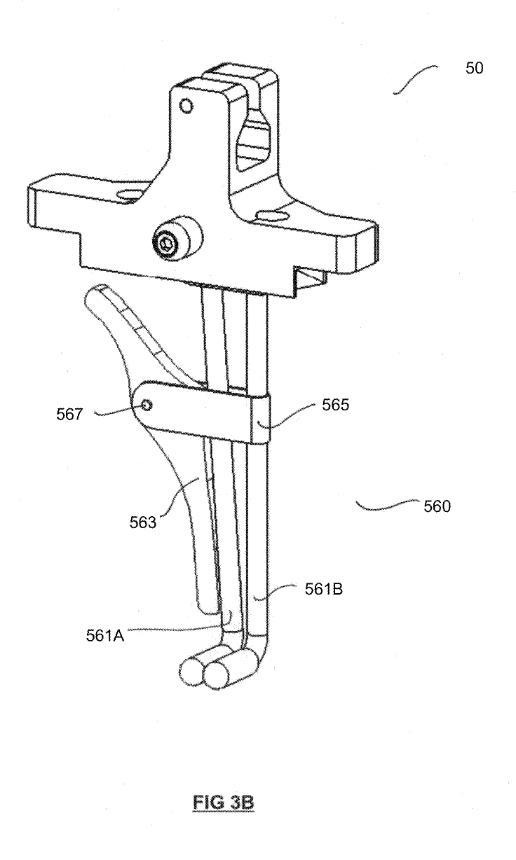

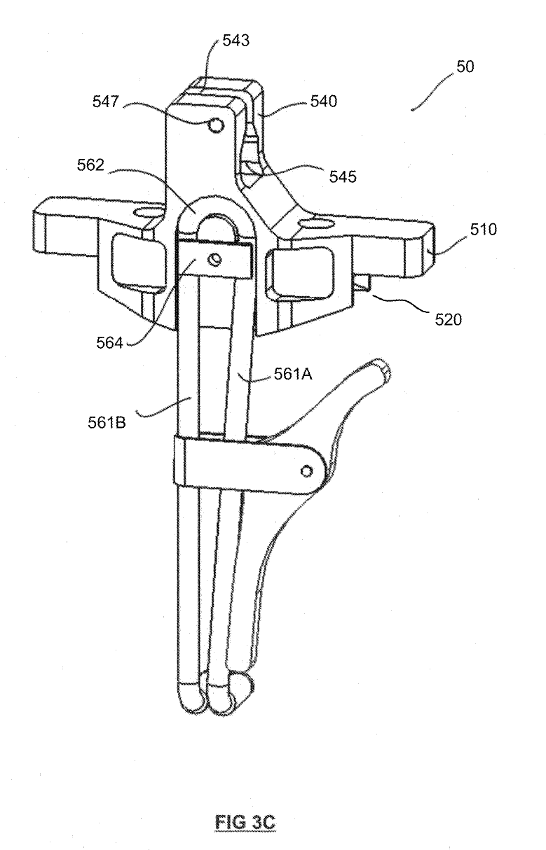

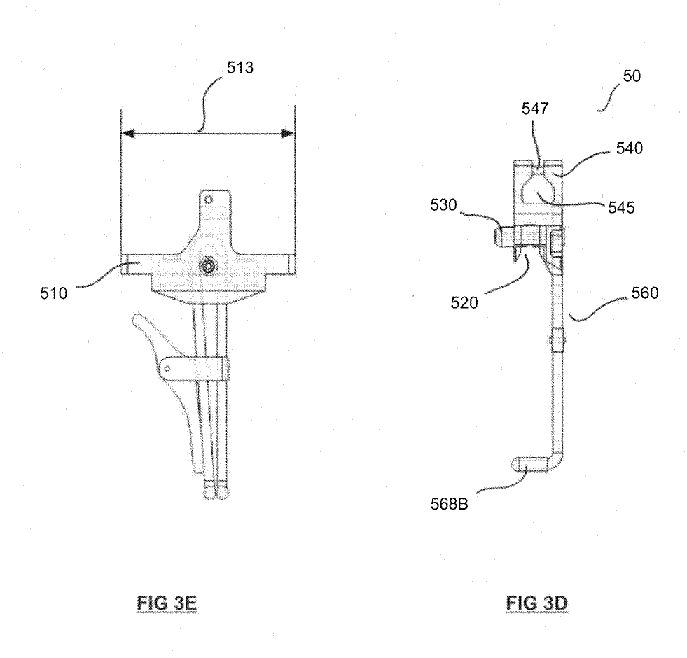

In some embodiments, an advantageous clamp can include an engagement block and an elongate securing member extending from the engagement block for removably clamping a product. Referring now to the exemplary illustrations of FIGS. 3A-3E, and without limitation, clamp 50 can include engagement block 510 for engagement though one or more features to a conveyor, a hook, and a screw. In some embodiments, engagement block 510 can be formed of a rigid material. For example, and without limitation, engagement block 510 may be formed of a high density polymer or a metal. In some embodiments, engagement block 510 can be formed of a low friction material. For example, and without limitation, engagement block 510 can be formed of polyacetal or nylon. In some embodiments, engagement block 510 may have a generally elongate base portion with a length 513 and an upwardly protruding top portion 540. However, it is to be appreciated that other shapes are contemplated in accordance with some embodiments of the present invention.

In some embodiments, engagement block 510 may have features integrally formed or attached thereto for slidable engagement with a conveyor. In some embodiments, a bottom portion of engagement block 510 may have a milling 520 associated therewith for slidable engagement with a top portion of a chain. For example, and without limitation, milling 520 may have a generally elongate channel defined by two smooth inner sidewalls and a smooth inner upper surface. In some embodiments, the channel may have a width about equal to a width of a chain (for example, and without limitation, chain of loading conveyor 20 as shown in FIG. 5). In some examples, and without limitation, milling 520 may further include one or more seating structures (generally shown in the example of FIG. 3D) for enabling the smooth placement of clamp 50 on a chain. In some embodiments, milling 520 may be integrally formed in engagement block 510. However, in some embodiments, milling 520 (or one or more parts thereof) may be fixedly attached to engagement block 510. For example, and without limitation, milling 520 (or one or more parts thereof) may be fixedly attached to engagement block 510 through screws, snap or slide fit connections. In some examples, and without limitation, one or more inner surfaces of milling 520 may be treated with a friction reducing agent, such as polytetrafluoroethylene. It is to be appreciated that other millings and locations on the engagement block thereof are contemplated in accordance with some embodiments of the present invention.

In some embodiments, engagement block 510 may have nipple 530 extending from a side portion thereof for engagement within a slot of an introduction screw. In some embodiments, nipple 530 may be integrally formed in engagement block 510. However, in some embodiments, nipple 530 may be fixedly attached to engagement block 510. For example, and without limitation, nipple 530 may be attached to a sidewall of engagement block 510 through a hex screw or snap fit connection. In some embodiments, the diameter of nipple 530 may correspond to a width of a slot in an introduction screw. In some embodiments, nipple 530 may have a circumferential surface comprising a low friction material to facilitate driving motion within the slot of the introduction screw. In some embodiments, nipple 530 may comprise an outer flanged or sleeve bushing or bearing for contact with the inner surface of the slot of the introduction screw. It is to be appreciated that other nipples and locations on the engagement block thereof are contemplated in accordance with some embodiments of the present invention.

In some embodiments, top portion 540 of engagement block 510 may have an opening 545 therein for receiving an elongate finger of a hook. In some embodiments, opening 545 may define a cavity extending between a front face and back face of top portion 540. However, in some embodiments, opening 545 may define a cavity in one of either a front face or back face of top portion 540. In some embodiments, and as shown, a top face of top portion 540 may include slot 543 extending along the length of the cavity formed by opening 545. In some embodiments, clamp 50 may further include rod 547 extending between the sides of slot 543. In some examples, and without limitation, rod 547 may be cylindrical allowing for hinged rotation between clamp 50 and an elongate finger of a hook. In some embodiments, top portion 540 may be integrally formed in engagement block 510. However, it is to be appreciated that top portion 540 may be attached to engagement block 510 through engaging means, such as for example, and without limitation, a screw, a snap, or slide fit connection. It is to be appreciated that other types of openings and locations on the engagement block thereof are contemplated in accordance with some embodiments of the present invention.

In some embodiments, elongate securing member 560 may include at least two about parallel rods 561A-561B extending downwardly from engagement block 510. As illustrated in the examples of FIGS. 3A-3B, and without limitation, rods 561A and 561B may be configured with an open position (see generally FIG. 3A) and a closed position (see generally FIG. 3B). In some embodiments, distal ends 568A-568B of rods 561A-561B may be about perpendicular to a main portion of the rods. In the open position, a gap may be provided between distal ends 568A-568B of rods 561A-561B, respectively, for disposing therebetween an elongate portion of the produce. For example, and without limitation, the stem of a bunch of grapes can be placed between distal ends 568A-568B of clamp 50 in an open position. It is to be appreciated that when clamp 50 is in a closed position, the stem may be compressed between the elongate rods with sufficient force to allow the produce to hang unsupported underneath from clamp 50. In some embodiments, the distal ends of the rods may be coated or formed of a compressible material for preventing damage to the stem of the produce. For example, and without limitation, silicone or rubber end pieces may be placed on the distal ends of the rods.

In some embodiments, elongate securing member 560 may include handle 563 pivotly engaged via pin 567 to strap 565 for commuting at least one of elongate rods 561A-561B between open and closed positions. For example, and without limitation, strap 565 may surround elongate rods 561A-561B. In some examples, handle 563 can have a generally V-shaped body having an open side with a fulcrum through which pin 567 may be placed. In the closed position, the closed side (for example, the side opposite to the open side) can apply a force on an outside surface of rod 561A causing distal end 568A to come into compressible contact with distal end 568B of rod 561B. However, it is to be appreciated that other means for commuting the elongate rods between open and closed positions are contemplated in accordance with some embodiments of the present invention. For example, and without limitation, a handle can be provided for causing one or both of the elongate rods to move inwardly towards each other in generally parallel directions. Referring now to the example of FIG. 3C, and without limitation, elongate rods 561A and 561B may be operatively engaged with at least one side portion of elongate block 510. In some examples, and without limitation, portions of the elongate rods may be placed between a side portion of elongate block 510 and restraining plate 564. In some examples, a bottom portion of elongate block 510 may have cavities (not shown) for receiving proximal ends of elongate rods 561A-561B. In some examples, and without limitation, elongate rods 561A-561B may be two ends of a generally U-shaped member having an about one hundred and eighty degree bend at joint 562. It is to be appreciated that other configurations of elongate rods and means for attaching them to the engagement block are contemplated in accordance with some embodiments of the present invention.

Exemplary Introduction Screws

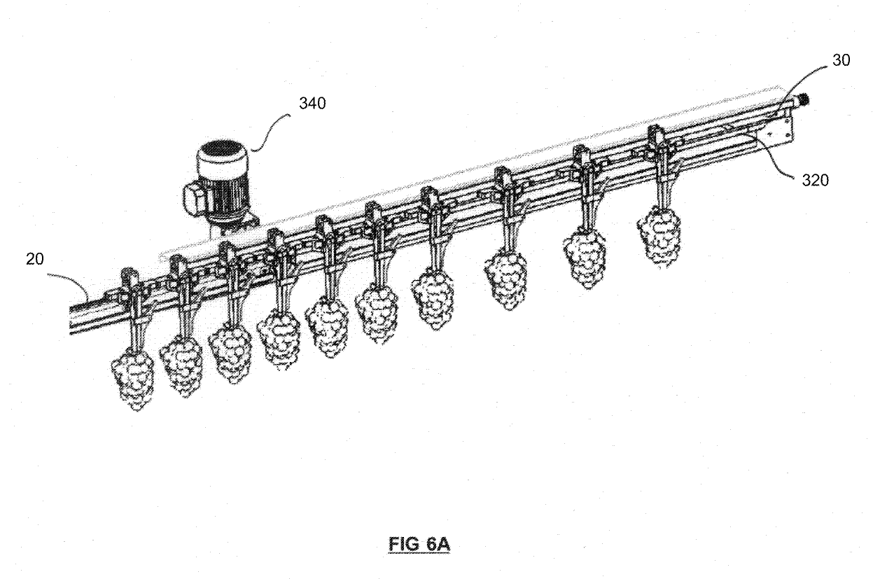

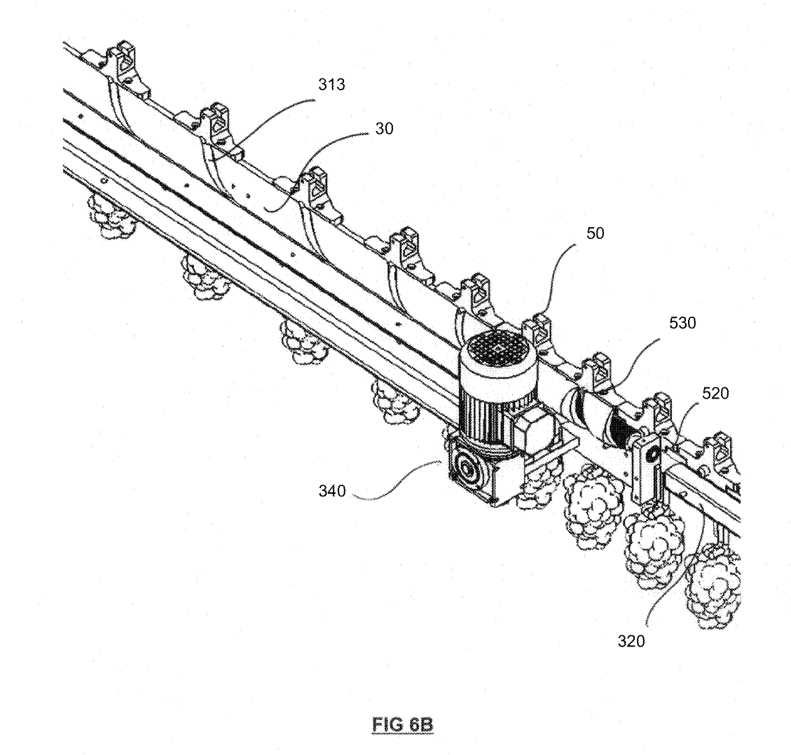

Referring now to the examples of FIGS. 6A-6B, the plurality of clamps may be conveyed along loading conveyor 20 to a first transfer location at a first end of endless introduction screw 30. As described above, the clamps may enter into introduction screw 30 fluently, if not in accumulation. For example, and without limitation, a plurality of clamps may accumulate at the first transfer location, end to end, wherein they may be taken into introduction screw 30 one at a time. In some embodiments, introduction screw 30 may have an outside surface with a helical slot 313 for driving a clamp via a nipple thereof. For example, and without limitation, nipple 530 of clamp 50 may engage with slot 313 thereby driving clamp 50 along introduction screw 30. In some embodiments, a rail or guide 320 may be disposed adjacent to introduction screw 30 for slidable engagement with milling 520 of clamp along the length of introduction screw 30. In some examples, and without limitation, a first end of guide 320 can be about coterminous and aligned with the functional end of loading conveyor 20 such that clamps may be smoothly transferred therebetween. As introduction screw 30 rotates, clamp 50 is moved (via nipple 530 engaged with slot 313 and, optionally, via milling 520 slidably engaged with guide 320) from a first end of introduction screw 30 to a second end.

In some embodiments, rotary motion may be imparted on introduction screw 30 by means 340. In some examples, and without limitation, means 340 may comprise a motor synchronized with the sizing conveyor. In other examples, means 340 may comprise gear multipliers or reducers engaged with a portion of the sizing conveyor. It is to be appreciated that introduction screw facilitates transfer of the clamps from the loading conveyor to the sizing conveyor. In some advantageous embodiments, the loading and sizing conveyors may operate at two different speeds. Thus, in some embodiments, the distance that a clamp moving along introduction screw 30 may be the same or different than one or both of the sizing conveyor and the loading conveyor.

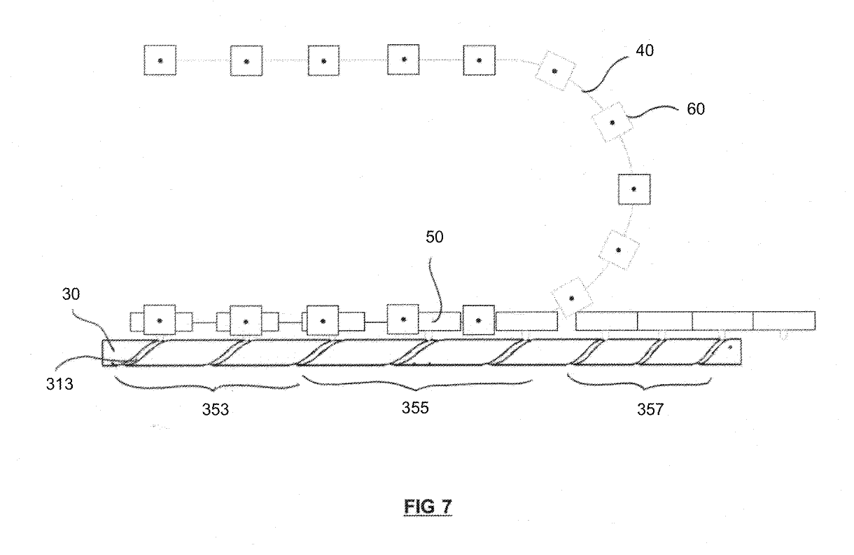

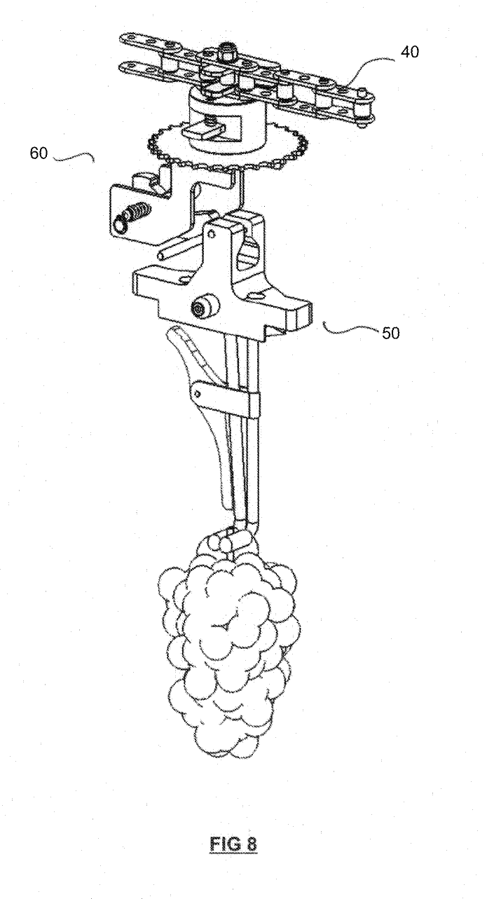

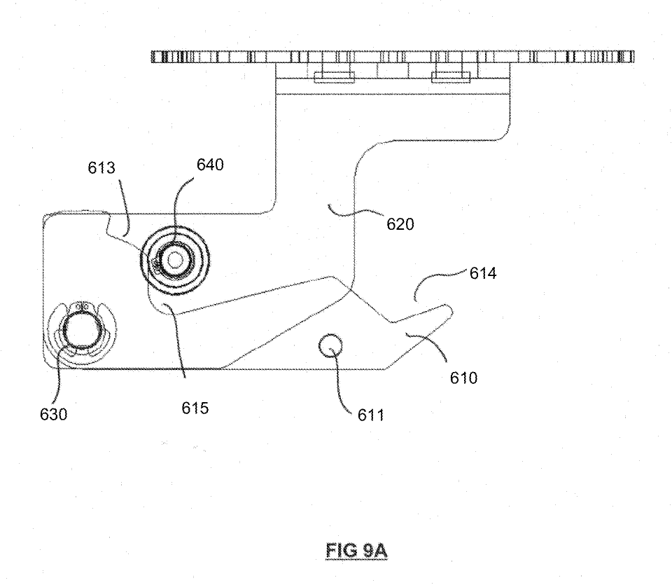

As above, the plurality of clamps may have openings for engaging with an elongate finger of hooks associated with the sizing conveyor. In some advantageous embodiments, helical slot 313 of introduction screw 30 may have a non-uniform or variable pitch for facilitating the transfer. Referring now to the example of FIG. 7, and without limitation, helical slot 313 of introduction screw 30 may comprise portions with differing pitches. For example, and without limitation, the pitch of slot 313 in first portion 357 may generally correspond to width 513 of engagement block 510 as shown in FIG. 3E. In some examples, second portion 353 may have a pitch which generally corresponds to the spacing distance between clamps 60 on sizing conveyor 40. A third, central portion 355 may have a pitch which is maximum, or slightly greater than the pitch of second portion 353 for accelerating and then decelerating clamp 50. As shown, a portion of sizing conveyor 40 may be parallel and adjacent to a portion of introduction screw 30 for facilitating slidable entry of a finger of hook 60 into the opening of clamp 50 at a location corresponding to third portion 355. In some examples, as illustrated in FIG. 8, and without limitation, hook 60 may be engaged with sizing conveyor 40 and have a finger for hanging clamp 50 through an opening therein. Referring back to FIG. 7, it is to be appreciated that the variable pitch of slot 313 of introduction screw 30 may (i) receive a plurality of clamps at a first spacing distance (for example, and without limitation, corresponding to width 513 of engagement block 510 as shown in FIG. 3E), (ii) accelerate the clamps to be in a forward position from a hook on the sizing conveyor, and (iii) decelerate the clamps such that the finger of the hook is inserted into the opening of the clamp.

It is further to be appreciated that the pitch of the various portions of slot 313 of introduction screw 30 may vary depending on, among other things, the spacing of hooks 60 on sizing conveyor 40, the width of the engagement block of the clamp 50, the speed of loading conveyor 20, the speed of sizing conveyor 40, and the rotational speed of introduction screw 30. For example, and without limitation, the pitch of first portion 357 of slot 313 and the rotational speed of introduction screw 30 may correspond to the linear group speed of clamps moving along loading conveyor 20 (the clamps of which may accumulate at the first end of introduction screw 30). Similarly, the pitch of second portion 353 of slot 313 and the rotational speed of introduction screw 30 may correspond to the speed of sizing conveyor 40 and the spacing distance between hooks 60 attached thereto. It is within the abilities of those in the art to provide introduction screws having different pitches and rotational speeds for transferring clamps from a loading conveyor to a sizing conveyor.

Exemplary Hooks

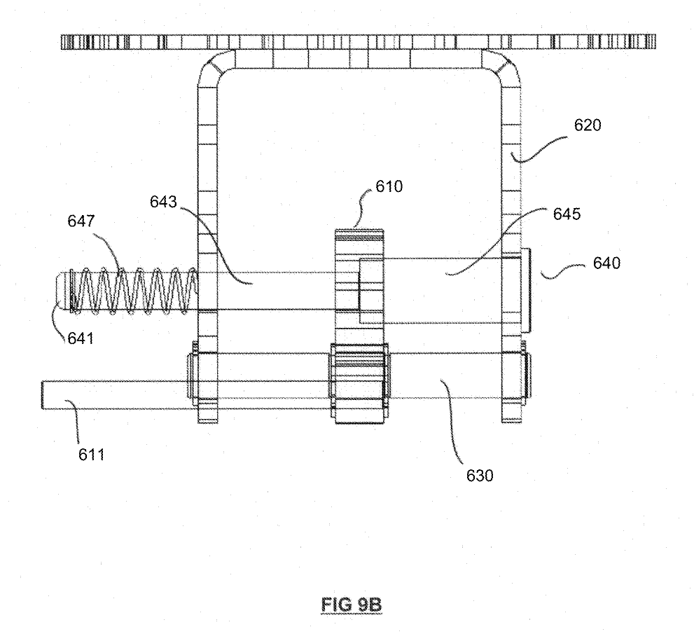

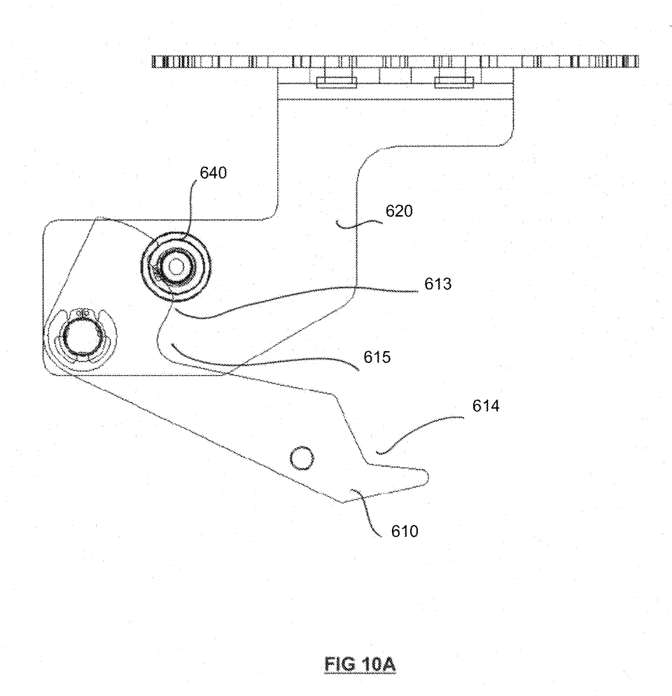

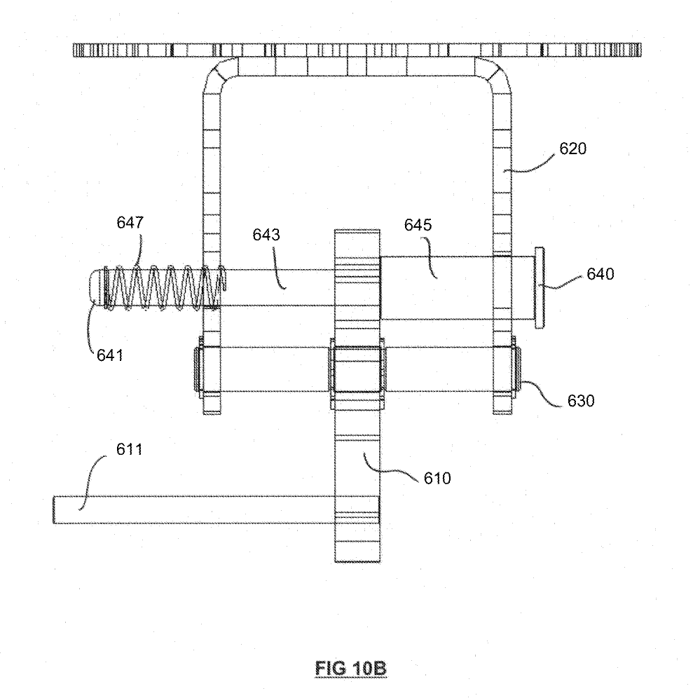

Referring now to FIGS. 9A-9B and 10A-10B, in advantageous embodiments, a hook may include elongate finger 610 hingedly engaged with fork joint 620 about a first axis through rotation pin 630. In some embodiments, fork joint 620 may include two parallel tines and elongate finger 610 may be disposed therebetween. In some embodiments, hook 60 may have a closed position (as generally shown in FIGS. 9A-9B) and an open position (as generally shown in FIGS. 10A-10B). In the open position, elongate finger 610 may extend downwardly from fork joint 620 for catching the clamp (for example, and without limitation, through an opening in an engagement block). In the closed position, elongate finger 610 may extend upwardly towards fork joint 620 and may be locked for opposing downward gravitational forces due to the weight of the clamp hinged on the distal end of elongate finger 610. In some embodiments, a distal end of elongate finger 610 may include bend 614. In some examples, referring specifically to FIG. 9A, and without limitation, bend 614 may be configured such that when the hook is in a closed position, the clamp may be hung in bend 614 (for example, and without limitation, by rod 547 as shown in FIGS. 3A-3D.

In some embodiments, commutation between the open and closed positions of the hook is facilitated by recesses or notches on a proximal end of the elongate finger, by a hooking pin, and by a spring-loaded locking pin. In some embodiments, hooking pin 611 is provided at about a distal end of elongate finger 610 for transferring movement to elongate finger 610. For example, and without limitation, upwards or downwards forces on hooking pin 611 may cause the distal end of elongate finger 610 to pivot upwardly or downwardly, respectively, around rotation pin 630. In some embodiments, spring-loaded locking pin 640 having a portion 645 with a first diameter and a portion 643 with a second diameter can extend between the tines of fork joint 620. In some embodiments, spring 647 may be provided between a distal end 641 of locking pin 640 and at least one of the tines of the fork joint. In some embodiments, elongate finger 610 can include a first notch 613 and a second notch 615 for operable engagement with portion 643 and portion 645 of locking pin 640.

It is to be appreciated that, in some examples, without limitation, and discussed more fully below, an upward force applied to hooking pin 611 will cause elongate finger 610 to move upwardly until second portion 645 of locking pin 640 is securely engaged in second notch 615 of elongate finger 610. Once engaged, disengagement will be prevented by restraining features of second notch 645. For example, and without limitation, a lip can be provided between first notch 613 and second notch 615 of elongate finger 610 with sufficient geometries such that second portion 645 of locking pin 640 cannot be disengaged from second notch 615 when normal gravitational forces applied to a distal end of elongate finger 610 (for example, due to the weight of the clamp and/or produce attached thereto). In some examples, without limitation, and discussed more fully below, disengagement of second portion 645 of locking pin 640 from second notch 615 of elongate finger 610 may be accomplished by a force applied to distal end 641 of locking pin 640, causing second portion 645 of locking pin to slidably disengage from second notch 645 of elongate finger. Once disengaged, distal end of elongate finger may pivot downwardly until first portion 643 of locking pin 640 is engaged in first notch 613 of elongate finger.

Transfer of Clamps from Exemplary Introduction Screws to Exemplary Sizing Conveyors

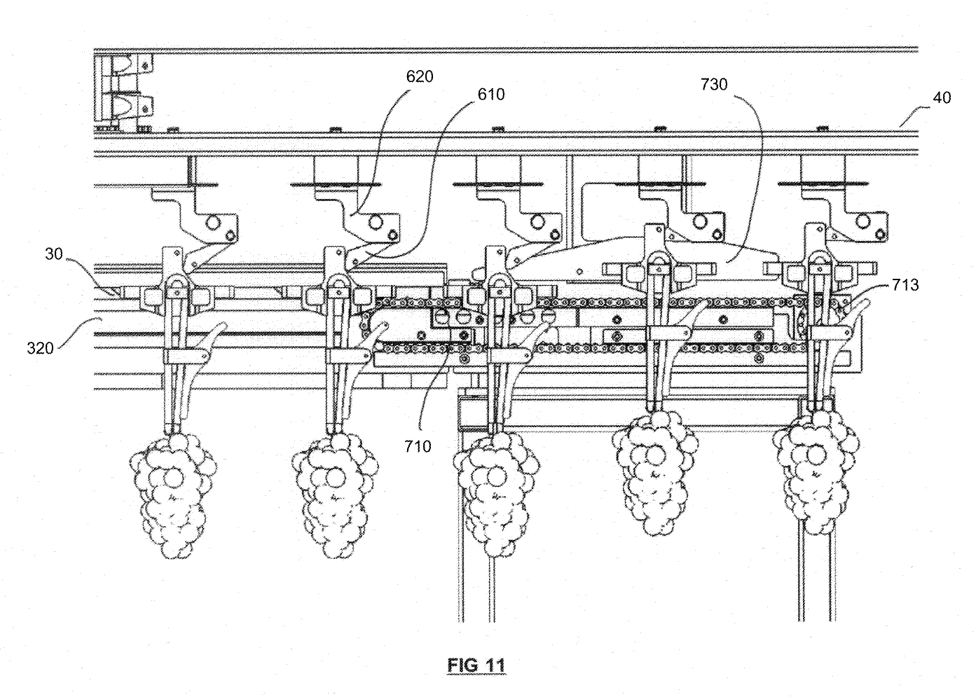

Referring now to the example of FIG. 11, in some embodiments, a hooking or loading ramp may be provided for applying an upward force to the hooking pin of the elongate finger, causing the hook to commute from an open position to a closed position. In some embodiments, the clamp may be conveyed as close to possible to the second end of introduction screw 30 to a second transfer location. It is to be appreciated that the variable helical slot provided on introduction screw 30 may cause elongate finger 610 to be inserted into an opening provided on the clamp. In some embodiments, at the second end of introduction screw 30, the clamp may nearly but not fully contact with elongate finger 610. In some embodiments, a weighing and/or transfer conveyor 713 can be provided to facilitate the weighing of the clamp and/or completely transferring the clamp onto the hook.

In some embodiments, scale 710 can be provided at the second transfer location for weighing the clamp with the produce attached thereto. For example, and without limitation, scale 710 can comprise a strain gauge load cell or a piezoelectric load cell. However, it is to be appreciated that other means for determining the weight of the clamp and/or product are contemplated in accordance with some embodiments of the present invention. In some embodiments, a second end of guide 320 can be about coterminous and aligned with a functional beginning of conveyor 713 such that clamps may be smoothly transferred therebetween. As the clamps are driven across scale 710 by conveyor 713, and before the clamp is in contact with elongate finger 620, a weight measurement can be made and stored in a computing means.

In some embodiments, hooking ramp 730 can be provided for applying an upward force on the hooking pin of elongate finger 610. In some embodiments, conveyor 713 operates at about the same speed as sizing conveyor 40. As the clamps are driven along conveyor 713, the hooking pins on the elongate fingers may come into slidable contact with a sloped upper face of hooking ramp 730, causing the hooks to commute from an open position to a closed position. As illustrated in the examples of FIGS. 9A-9B and 10A-10B, in some embodiments, the hook may include a locking pin which may be securely engaged in one or notches provided on elongate finger 620. It is to be appreciated that once the hook commutes between an open and closed position, the clamp may hang therefrom supported by the elongate finger.

Exemplary Rotational Hooks

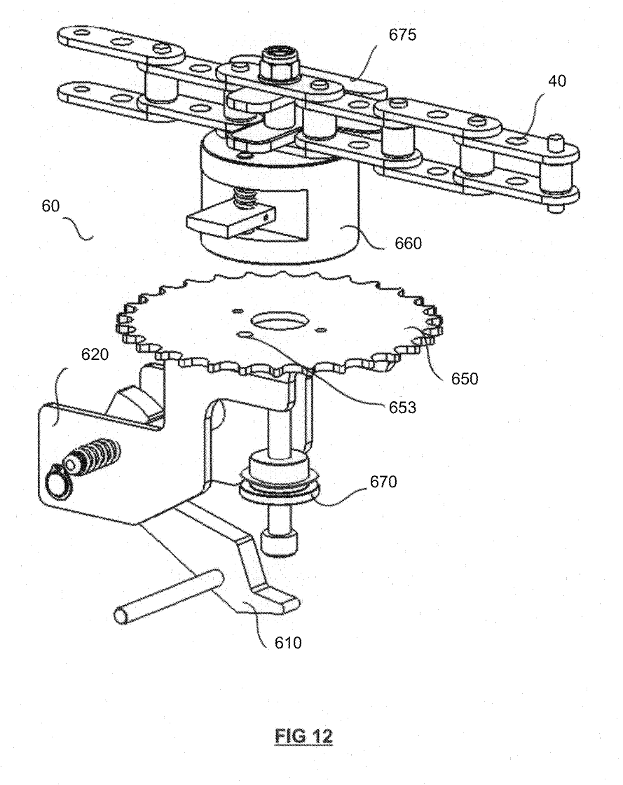

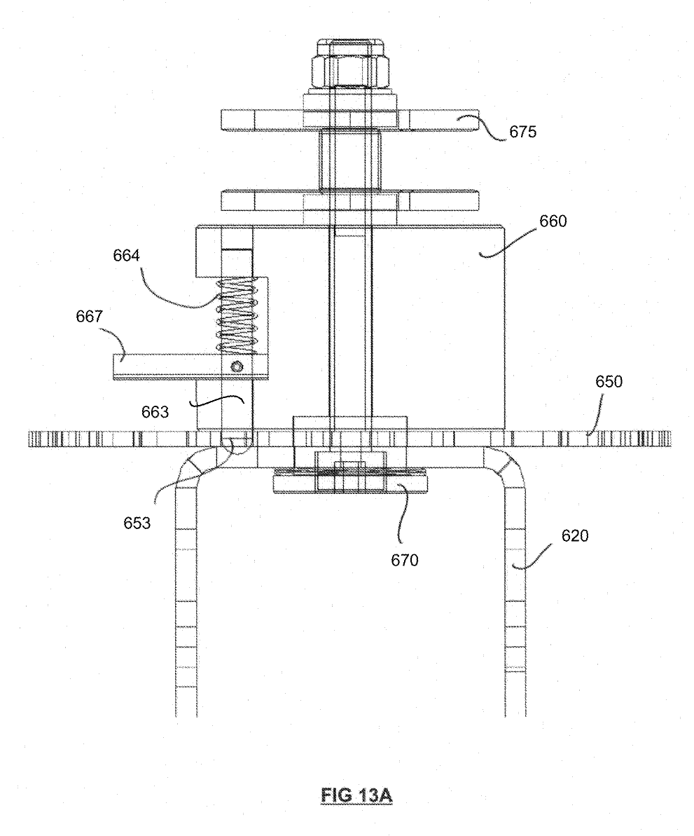

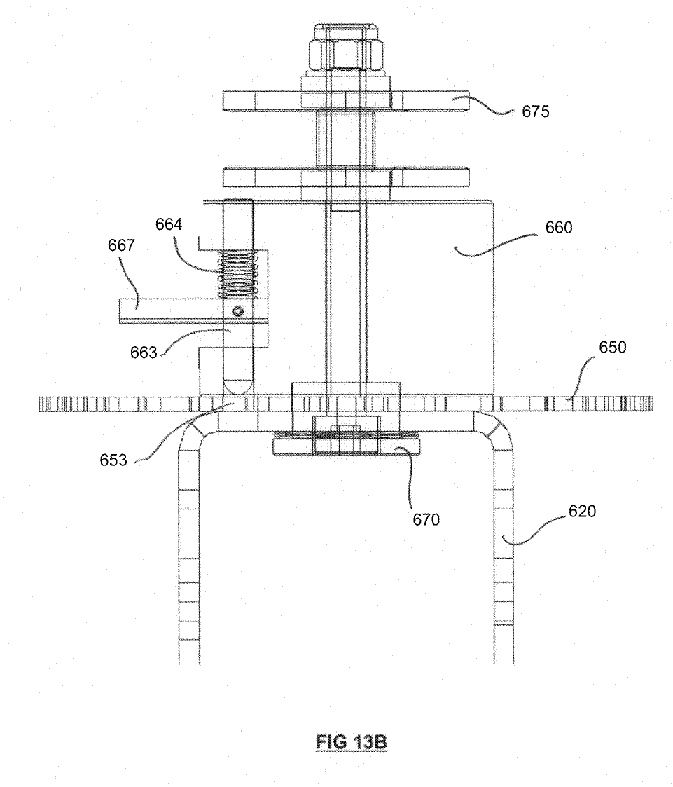

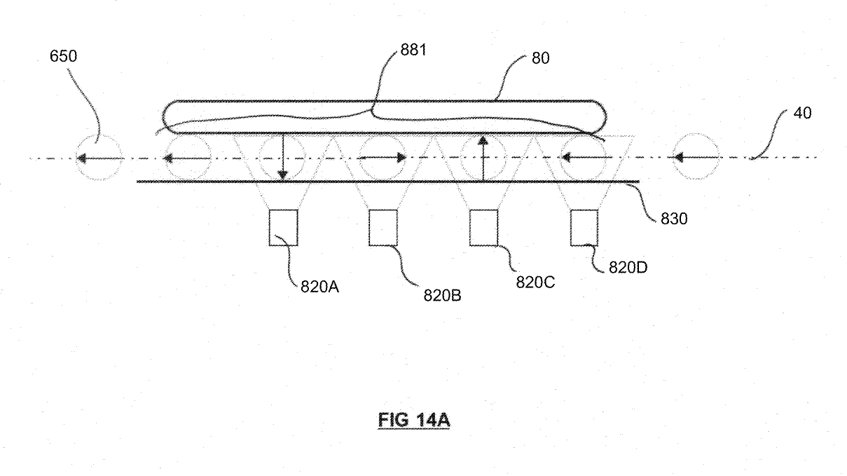

As above, some advantageous systems in accordance with embodiments of the present invention enable image capturing of a plurality of sides of the produce. In some advantageous embodiments, the hooks may have features for causing the clamp (engaged with the elongate finger) to rotate while simultaneously being conveyed along the sizing conveyor. Referring now to FIGS. 12 and 13A-13B, and without limitation, in some embodiments clamp 60 may further include gear wheel 60 rotationally coupled to rotation block 660 through rotation pin 670. In some examples, and without limitation, gear wheel 650 may have a bottom surface fixedly engaged with fork joint 620.

It is to be appreciated that rotational force applied to a circumferential edge of gear wheel 650 may cause gear wheel 650 (and thus fork joint 620 and elongate finger 610) to rotate relative to rotation block 660 and/or sizing conveyor 40. Thus, in some embodiments, gear wheel 650 may include a plurality of teeth or notches at a circumferential edge thereof for engaging with corresponding features of a driving member, such as a chain or a belt.

In some embodiments, rotational block 660 may be fixedly engaged with sizing conveyor 40 via an insertion 675. In some examples, and without limitation, insertion 675 can have features for inserting between plates and bushings of sizing conveyor 40. In some embodiments, the plates of sizing conveyor 40 can include holes through which rotation pin 670 may extend. In some embodiments, rotation pin 670 may further be engaged with a portion of insertion 675.

As illustrated in the examples of FIGS. 13A-13B, the hook can have a locked and an unlocked position, respectively. In some embodiments, rotation block 660 can include spring-loaded locking pin 663. In some embodiments, locking pin 663 can include spring 664 located between a wall of rotation block 660 and locking trigger 667. In some examples, locking trigger 667 may be fixed with and extend about perpendicularly from locking pin 663. It is to be appreciated that as an upward force is applied to locking trigger 667, spring 664 may compress, thereby raising locking pin 663.

In some embodiments, gear wheel 650 can include one or more locking holes at locations corresponding to the locking pin. For example, and without limitation, gear wheel 650 can include locking hole 653 for removable insertion therein of locking pin 663. Downward commutation of locking pin 663 via locking trigger 667 and/or spring 664 may cause the distal end of locking pin 663 to engage in locking hole 653, thereby preventing rotational movement of gear wheel 650 with respect to locking block 660 and thus sizing conveyor 40.

It is to be appreciated that, in some advantageous embodiments, a hook can enable a plurality of directional movements of a clamp engaged with a product to be sized and conveyed. For example, and without limitation, pivotal rotation of an elongate finger with respect to a fork joint may cause the clamp to move up and down with respect to the sizing conveyor. The clamp, once engaged with the elongate finger, may also rotate about an axis orthogonal to a direction of movement of the sizing conveyor by the application of an upward force to a locking trigger associated with a locking pin and by the application of a rotational force on a circumferential edge of a gear wheel.

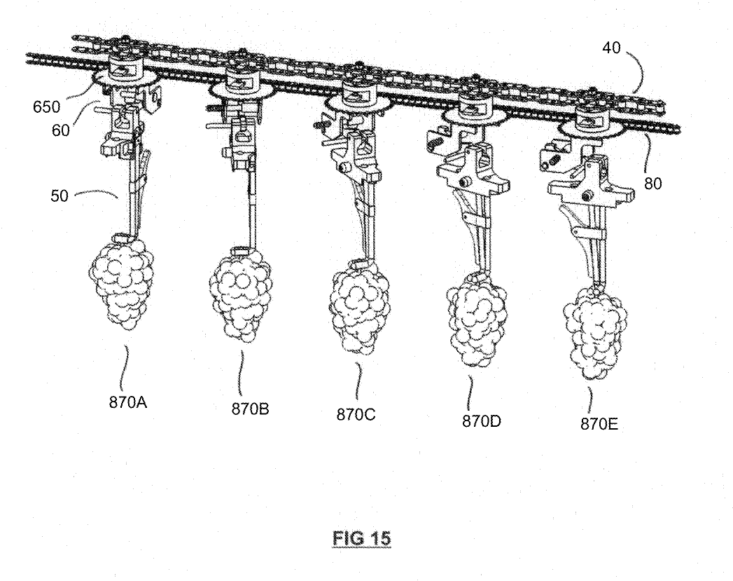

As shown in the example of FIG. 15, and without limitation, in some embodiments, driving member 80 can be provided parallel and adjacent to a portion of sizing conveyor 40. In some examples, and without limitation, driving member 80 may comprise a roller chain. In some other embodiments, driving member 80 may comprise a belt. As clamp 50 (which may be engaged with hook 60) moves along sizing conveyor 40, engagement of driving member 80 with gear wheel 650 causes clamp 50 (and thus produce hanging therefrom) to rotate about a central axis. As illustrated, and without limitation, clamp 50 may rotate about 90 degrees between positions 870A and 870E. It can be appreciated that the rotational speed of the clamp must not be so fast as to cause the produce attached thereto to sway from a central position, thus potentially affecting the imaging process or causing one or more elements of the product to be dislocated therefrom.

Rotational Imaging

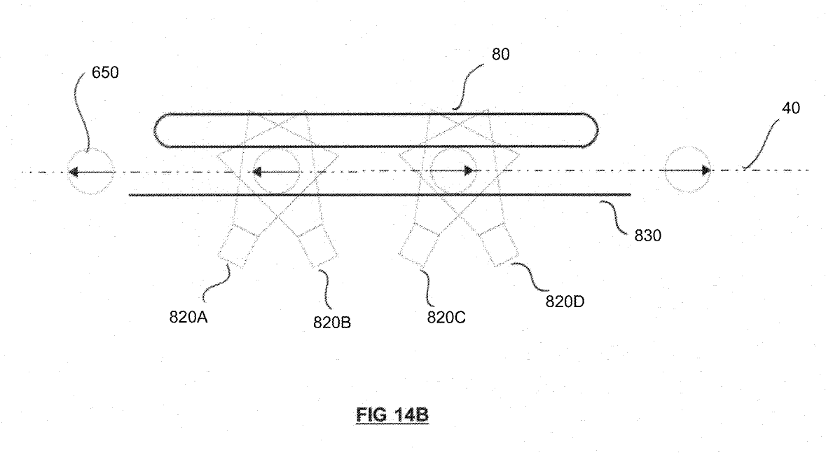

Referring now to FIGS. 14A-14B, in some embodiments, at least one camera may be proximally disposed to a portion of the sizing conveyor defining an imaging portion for capturing images from at least one side of a product. In some examples, and without limitation, as a hook moves along conveyor 40, a locking trigger associated with a locking pin may encounter a plow 830 causing the locking pin to disengage from a locking hole on gear wheel 650. As the circumferential edge of gear wheel 650 encounters driving member 80, cooperation of teeth on the circumferential edge of gear wheel 650 with corresponding bushings and plates of driving member 80 may cause gear wheel 650 to rotate about a first axis.

In some examples, and without limitation, cameras 820A-820D can be provided adjacent to driving member 80 for capturing images of the product as it rotates while engaged with sizing conveyor 40. Referring to FIG. 14A, in some embodiments, cameras 820A-820D may be evenly spaced and may each have the same angular orientation (or normal fields of views). In some embodiments, the product may complete a full rotation through imaging portion 881. For example, and without limitation, gear wheel 650 may complete a full rotation as it passes through the field of view of cameras 820A-820D. In some examples, the product may complete more than a full rotation through imaging portion 881. For example, the gear wheel may rotate 540 degrees though the field of view of cameras to obtain better imaging resolution. However, it is to be appreciated that the cameras may not be evenly spaced, the cameras may not have the same angular orientation, and the product may complete other degrees of rotation through the imaging portion.

Referring to FIG. 14B, and without limitation, cameras 820A-820B may be unevenly spaced and may have varying angular orientations. In some embodiments, gear wheel 650 may complete a one hundred and eighty degree rotation as is passes through the field of views of cameras 820A-820D. In some examples, and without limitation, the product may be simultaneously imaged by cameras 820A and 820B, which may have a ninety degree offset in their respective angular orientations. In some embodiments, at least one of the cameras can have an angular offset between about 30 and about 150 degrees from a direction of travel of the conveyor. For example, and without limitation, camera 820A may have an angular orientation of about 45 degrees from the direction of travel of conveyor 40. The product may then rotate one hundred and eighty degrees before being simultaneously imaged by cameras 820C and 820D. Those in the art can recognize other configurations of rotational imagers in accordance with some embodiments of the present invention.

In some embodiments, driving member 80 may operate at a speed, relative to a speed of sizing conveyor 40, determined with reference to the speed of sizing conveyor 40, the length of the circumferential edge of gear wheel 650, and the length of imaging section 881. For example, referring to FIG. 14A, and without limitation, gear wheel 650 may complete one full rotation in imaging portion 881. It is to be appreciated that amount of time T that gear wheel 650 takes to move from one end of imaging portion 881 to the other may be about equal to the length X of imaging portion 881 divided by the speed A of sizing conveyor 40. During this time T, gear wheel 650 having a circumferential edge length L may complete one full rotation. Thus, in some embodiments, driving member 80 may operate at a speed, relative to the speed of sizing conveyor 40, of at least L times A divided by X. It is within the abilities of those in the art to provide driving members having other speeds depending on, among other things, the amount of rotation desired through the imaging section, the circumferential edge length of the gear wheel, the speed of the sizing conveyor, and the length of the imaging section.

Sorting and Packaging

As above, in some embodiments, a computing means may be in communication with the weighing station and/or imaging station for determining one or more metrics associated with the produce attached to a given clamp. In some examples, and without limitation, the computing means can calculate a metric corresponding to the weight of the produce by subtracting a premeasured weight of the clamp from the combined weight of the clamp and the produce (as measured, for example and without limitation, by a scale). In some examples, and without limitation, the computing means can also calculate a metric corresponding to the visual integrity of the produce (as determined, for example and without limitation, by one or more imaging sensors). In some other examples, the computing means can calculate a qualitative metric corresponding to both the weight and visual integrity of the produce.

For each clamp associated with a hook on the sizing conveyor, the computing means may determine to which of a plurality of unloading stations the clamp should be allocated. For example, and without limitation, a clamp having produce with a weight within a certain range and a visual integrity of a certain value may be assigned to one or more of the unloading stations. In some advantageous embodiments, computing means can allocate clamps to the unloading stations such that the total net weight of produce on a plurality of allocated clamps is as close to a desired minimum net pack weight.

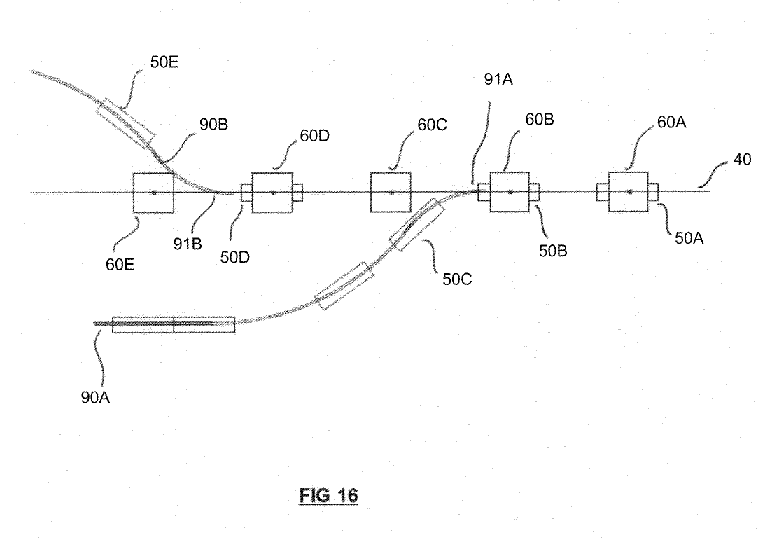

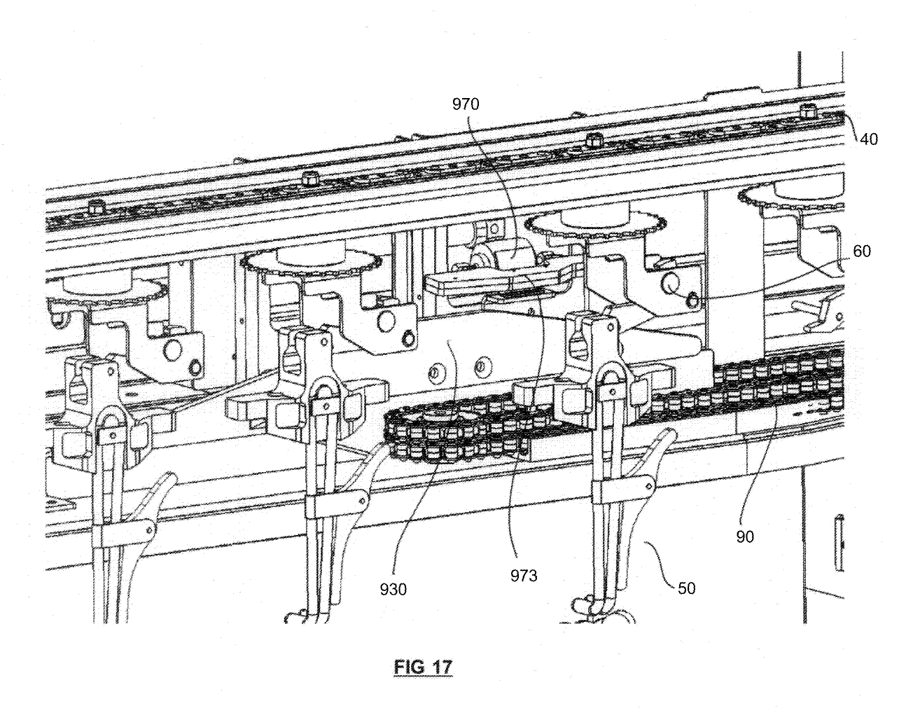

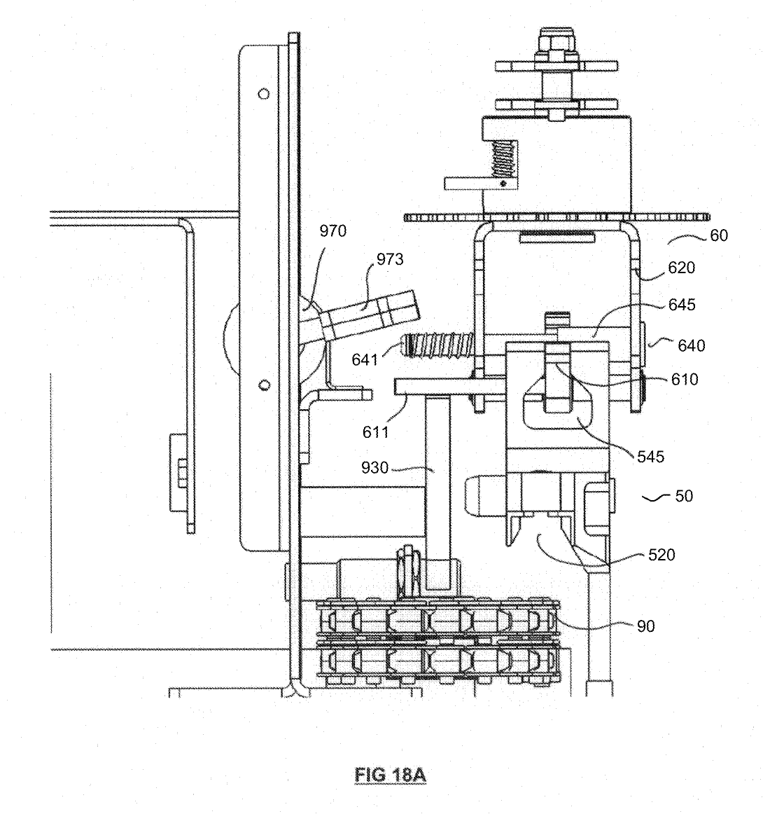

Referring now to FIG. 16, and without limitation, sizing conveyor 40 may have a plurality of hooks 60A-60E engaged therewith travelling past a plurality of unloading locations 91A-91B. As the hooks move past the unloading locations, unhooking means may selectively remove a clamp from a hook, and discharge the clamp onto an outlet conveyor. For example, and without limitation, hook 60A with clamp 50A engaged therewith may travel along sizing conveyor 40 towards unloading locations 91A and 91B. At unloading location 91A, unhooking means in communication with computing means may cause the clamp to disengage from the hook, with the hook continuing travel along the sizing conveyor and the clamp continuing travel along outlet conveyor 90A. As illustrated, clamp 50C has been disengaged from hook 60C at unloading location 91A, while clamp 50D was not disengaged from hook 60D at unloading location 91A. As illustrated in FIG. 17, in some examples, and without limitation, hook 60 may travel along sizing conveyor 40 at an unloading location. If clamp 50 is to be disengaged from hook 60 and placed on outlet conveyor 90, computing means may activate electromagnet 970, causing cam 973 to rotate and unlock the elongate finger of hook 60. An unloading ramp 930 may have a sloped upper surface upon which a hooking pin may follow as hook 60 commutes between a closed position and an open position.

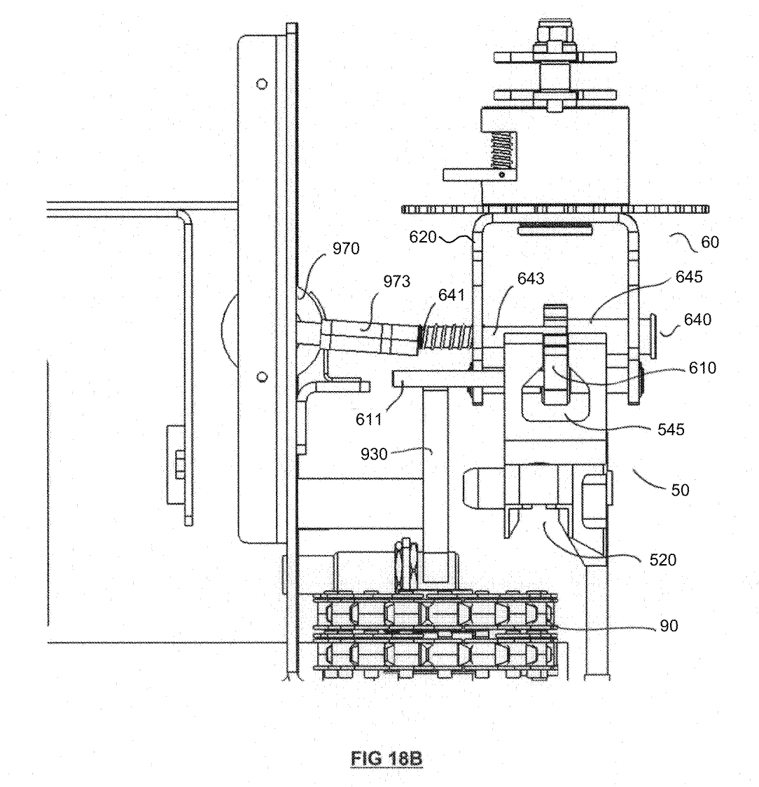

Referring now to FIGS. 18A-18B, in some embodiments, clamp 50 engaged with hook 60 may be oriented such that milling 520 is aligned with outlet conveyor 90. In some embodiments, electromagnet 970 and unhooking cam 973 attached thereto may have a first orientation and a second orientation. In some examples, and without limitation, the first and second orientations may be separated by about ten degrees. In some examples, as illustrated in FIG. 18A, and without limitation, the first orientation of electromagnet 970 and unhooking cam 973 may be such that it does not interfere with distal end 641 of locking pin 640 as hook 60 passes thereby. As illustrated in FIG. 18B, the second orientation can be such that distal end 641 of locking pin 640 is brought into contact with a sloped side face of cam 973, thereby imparting an inward force on spring-loaded locking pin 640 to disengage second portion 645 of locking pin 640 from a notch (not shown) in elongate finger 610. As above and with reference to FIG. 10A, disengagement of second portion 645 of locking pin 640 allows a distal end of elongate finger 610 to pivot downwardly until the hook is in an open position.

In some embodiments, as elongate finger pivots into the open position, hooking pin 611 may be brought into contact with a sloped upper face of an unhooking ramp 930. In some examples, and without limitation, hooking pin 611, when following the sloped upper face of unhooking ramp 930, may provide for smooth commutation of elongate finger 610 between closed and open positions. As the distal end of elongate finger 610 pivots downwardly, clamp 50 (which in some examples, and without limitation, may be hingedly resting in a bend of the distal end of elongate finger) may be slowly lowered until milling 520 is slidably engaged with a top portion of outlet conveyor 90.

In some embodiments, outlet conveyor 90 can transport a plurality of clamps from the unloading location (where the clamps may be unloaded from the sizing conveyor) to an unloading station (where the product may be disengaged from the clamps and packaged into bags and/or boxes). As shown in FIGS. 19-20, in some examples, and without limitation, the clamps may travel along outlet conveyor 90 and accumulate at an entrance to an indexer 950. It is to be appreciated that in some advantageous embodiments the clamps may accumulate on the outlet conveyor, and thus the sizing and packaging operations can be asynchronous. For example, the rate at which the product is packaged may be independent of the rate at which clamps are allocated to a given unloading station. In some advantageous embodiments, if a clamp is allocated to a given unloading station however additional clamps are unable to be placed on the outlet conveyor associated therewith, a terminal unloading location may disengage any clamps remaining on the hooks of the sizing conveyor and transfer them back to the loading conveyor.

The present invention thusly provides methods, apparatuses, and systems for conveying, sizing, sorting, and packaging stemmed produce, such as bunches of grapes and truss tomatoes, wherein loading, sizing, and packaging operations are asynchronous. It is to be understood that variations and/or modifications of the present invention may be made without departing from the scope of thereof. It is also to be understood that the present invention is not to be limited by the specific embodiments, descriptions, or illustrations or combinations of either components or steps disclosed herein. Thus, although reference has been made to the accompanying figures, it is to be appreciated that these figures are exemplary and are not meant to limit the scope of the present invention.

What is claimed is:

1. A system comprising:
a. a plurality of clamps, each said clamp comprising (i) an engagement block comprising a milling, a nipple, and an opening and (ii) an elongate securing member extending from said engagement block for removably clamping a product hanging therefrom;
b. a loading conveyor comprising a first endless chain for conveying said plurality of clamps from at least one loading station to a first transfer location, wherein said first endless chain has a top portion for slidable engagement with said millings of said clamps;
c. an introduction screw and guide for conveying said plurality of clamps from said first transfer location to a second transfer location, wherein said introduction screw has an outside surface comprising a helical slot for engagement with said nipples of said clamps and wherein said guide has a top portion for slidable engagement with said millings of said clamps;
d. a sizing conveyor comprising a second endless chain for selectively conveying said plurality of clamps from said second transfer location to one of a plurality of unloading locations, wherein said second endless chain has a plurality of hooks engaged therewith, each of said hooks comprising an elongate finger having a distal end for insertion into said opening of one of said clamps; and
e. a plurality of outlet conveyors each comprising an endless chain for conveying said plurality of clamps from said unloading locations to at least one unloading station, wherein each said chain has a top portion for slidable engagement with said millings of said clamps.

2. The system of claim 1, wherein a transfer portion of said sizing conveyor is parallel and adjacent to a transfer portion of said introduction screw, and wherein said distal ends of elongate fingers of said hooks on said transfer portion of said sizing conveyor are aligned with said openings of said clamps on said transfer portion of said introduction screw.

3. The system of claim 2, wherein said helical slot has a pitch that varies along a length of said introduction screw.

4. The system of claim 3, wherein said pitch is about maximum at a location between said first transfer location and said second transfer location.

5. The system of claim 3, wherein said pitch at said first transfer location is about less than said pitch at said second transfer location.

6. The system of claim 3, wherein said pitch at said first transfer location is about equal to a width of said engagement block of said clamp.

7. The system of claim 3, wherein said pitch at said second transfer location is about equal to a distance between adjacent hooks on said sizing conveyor.

8. The system of claim 1, each of said hooks further comprising:
a. a fork joint comprising at least two tines, wherein said elongate finger is pivotly engaged with said fork joint about a first axis;
b. a hooking pin extending from a side of said elongate finger, wherein said hooking pin is about parallel with said first axis; and
c. a spring-loaded locking pin extending between said tines of said fork joint, wherein said locking pin is about parallel with said first axis.

9. The system of claim 8, said locking pin comprising a first portion having a first diameter and a second portion having a second diameter greater than said first diameter, and said elongate finger further comprising a proximal end having a first notch corresponding to said first portion of said locking pin and a second notch corresponding to said second portion of said locking pin.

10. The system of claim 9, wherein each of said hooks have an unlocked position when said first notch of said elongate finger is engaged with said first portion of said locking pin and a locked position when said second notch of said elongate finger is engaged with said second portion of said locking pin.

11. The system of claim 10, further comprising a hooking ramp at said second transfer location having a sloped upper face for contacting said hooking pins and pivoting said elongate fingers until said hooks are in said locked position.

12. The system of claim 10, further comprising, at each of said unloading locations, an unhooking cam having a sloped side face for contacting distal ends of said locking pins and moving said locking pins inwardly until said second notches of said elongate fingers are disengaged with said second portions of said locking pins.

13. The system of claim 12, further comprising, at each of said unloading locations, an unhooking ramp having a sloped upper face for contacting said hooking pins and pivoting said elongate fingers until said hooks are in said unlocked position.

14. The system of claim 1, further comprising a scale at said second transfer location for weighing said product hanging from each said clamp.

15. The system of claim 14, further comprising an endless chain having a top portion for slidable engagement with said millings of said clamps.

16. The system of claim 1, further comprising at least one camera for imaging said product hanging from each said clamp.

17. The system of claim 16, each of said hooks further comprising:
a. a rotation block fixedly engaged with said sizing chain, said rotation block comprising a spring-loaded locking pin and a locking trigger extending from said locking pin; and
b. a gear wheel operatively engaged with said elongate finger and rotatably engaged with said rotation block, said gear wheel comprising a locking hole for receiving a distal end of said locking pin of said rotation block.

18. The system of claim 17, further comprising a driving member corresponding to said gear wheels of said hooks for asynchronously rotating said gear wheels with respect to said sizing chain, said driving member comprising one of the group consisting of a chain, a belt, and combinations thereof.

19. The system of claim 17, further comprising a plow for raising and holding said locking trigger to cause said distal end of said locking pins of said rotation blocks to dislocate from said locking holes of said gear wheels.

20. A system for sizing and packing a product comprising:
a. a clamp comprising (i) an engagement block comprising a milling, a nipple, and an opening and (ii) an elongate securing member extending from said engagement block for removably clamping said product hanging therefrom;
b. a loading conveyor having a first endless chain with a top portion for slidable engagement with said milling of said clamp;
c. a sizing conveyor having a second endless chain with a hook engaged therewith, said hook comprising an elongate finger with a distal end for insertion into said opening of said clamp;
d. an introduction screw having an outside surface comprising a helical slot with a variable pitch for engagement with said nipple of said clamp, wherein said introduction screw aligns said opening of said clamp with said elongate finger of said hook;
e. an outlet conveyor comprising a third endless chain having a top portion for slidable engagement with said milling of said clamp;
f. a weighing station for determining the weight of said product;
g. an imaging station for imaging said product; and
h. a computer in communication with said weighing station and said imaging station.

21. The system of claim 20, said hook further comprising:
a. a fork joint comprising at least two tines, wherein said elongate finger is pivotly engaged with said fork joint about a first axis;
b. a hooking pin extending from a side of said elongate finger, wherein said hooking pin is about parallel with said first axis;
c. a first spring-loaded locking pin extending between said tines of said fork joint, said locking pin comprising a first portion having a first diameter and a second portion having a second diameter greater than said first diameter, wherein said locking pin is about parallel with said first axis, said locking pin;
d. a rotation block fixedly engaged with said sizing chain, said rotation block comprising a second spring-loaded locking pin and a locking trigger extending from said locking pin; and
e. a gear wheel fixedly engaged with said fork joint and rotatably engaged with said rotation block about a second axis, said second axis perpendicular to said first axis, said gear wheel comprising a locking hole for receiving a distal end of said second locking pin.

22. The system of claim 21, further comprising a hooking ramp having a sloped upper face adjacent to a path of said hooking pin of said hook on said sizing conveyor, wherein an upward force is applied to said hooking pin causing said distal end of said elongate finger to pivot upwardly until a notch in a proximal end of said elongate finger is engaged with said second portion of said first locking pin.

23. The system of claim 21, further comprising a unhooking cam and an unhooking ramp, said unhooking cam in communication with said computer and having a sloped side face for contacting a distal end of said first locking pin of said hook as said hook is moving on said sizing conveyor, wherein an inward force is applied to said first locking pin causing said first locking pin to move inwardly until a notch in a proximal end of said elongate finger is disengaged with said second portion of said first locking pin.

24. The system of claim 23, further comprising an unhooking ramp having a sloped upper face for contacting said hooking pin of said hook as said hook is moving on said sizing conveyor after said unhooking cam has applied said inward force to said first locking pin.

25. The system of claim 21, said imaging station comprising a driving member for engagement with said gear wheel of said hook and for causing said gear wheel to rotate about said second axis while said hook is moving on said sizing conveyor, said driving member comprising one of the group consisting of a chain, a belt, and combinations thereof.

26. The system of claim 25, said imaging station further comprising at least one camera for capturing at least one image of said product as said product rotates about said second axis.

27. The system of claim 25, said imaging station further comprising a plow for lifting and holding said locking trigger as said gear wheel is rotating about said second axis.

28. A method for sorting and packaging a harvested agricultural crop comprising the steps of:
a. at a loading station, temporarily attaching a distal end of a clamp to a stem of said crop and slidably engaging a milling of said clamp with a first endless chain;
b. moving said first endless chain to transport said clamp to a first end of an introduction screw;
c. engaging a nipple of said clamp with a helical slot on an outside surface of said introduction screw and rotating said introduction screw to transport said clamp from said first end of said introduction screw to a second end of said introduction screw;
d. discharging said clamp from said second end of said introduction screw onto a weighing station and determining a weight of said clamp and said crop attached thereto;
e. inserting a distal end of an elongate finger of a hook engaged with a second endless chain through an opening of said clamp and moving said second endless chain to transport said clamp to a discharge location;
f. slidably engaging said milling of said clamp with a third endless chain and moving said third endless chain to transport said clamp to an unloading station; and
g. at said unloading station, disengaging said clamp from said third endless chain and detaching said distal end of said clamp from said stem of said crop.

29. The method of claim 28, further comprising the step of slidably engaging said milling of said clamp with a guide, said guide located adjacent to and parallel with a portion of said introduction screw.

30. The method of claim 28, said weighing station comprising a scale and a fourth endless chain, further comprising the step of slidably engaging said milling of said clamp with said fourth endless chain and moving said fourth endless chain to transport said clamp onto said scale.

31. The method of claim 28, further comprising the step of capturing at least one image of said crop as said clamp is transported to said unloading station.

32. The method of claim 31, said hook further comprising a gear wheel engaged with said elongate finger and rotably engaged with a rotation block engaged with said chain, further comprising the step of rotating said gear wheel while capturing said at least one image.

33. The method of claim 32, further comprising the step of engaging said gear wheel with a driving member, said driving member having a portion about parallel to a portion of said second endless chain, said driving member comprising one of the group consisting of a chain, a belt, and combinations thereof.

34. The method of claim 28, further comprising the step of at least partially inserting said distal end of said elongate finger in said opening of said clamp at a location between said first and said second end of said introduction screw.

35. The method of claim 28, said elongate finger hingedly engaged about a first axis with a joint of said hook and having a hooking pin extending therefrom and about parallel to said first axis, further comprising the step of applying an upward force to said hooking pin to lift said elongate finger upwardly into a locked position.

36. The method of claim 28, said elongate finger hingedly engaged about a first axis with a joint of said hook and having a spring-loaded locking pin disposed therein and about parallel to said first axis for engaging with a proximal end of said elongate finger, further comprising the step of applying an inward force to said locking pin to disengage said proximal end of said elongate finger from said locking pin.

37. A clamp for conveying a product along each of a chain, a hook with an elongate finger, and an introduction screw with a helical slot on an outside surface thereof, comprising:
a. an engagement block comprising a top portion having a front face and a back face, a bottom portion, and at least two side portions;
b. a milling associated with said bottom portion of said engagement block, said milling having a first inner sidewall and a second inner sidewall defining an elongate channel with a width corresponding to a width of said chain;
c. a nipple extending about perpendicularly from one of said side portions of said engagement block, said nipple having a diameter corresponding to a diameter of said helical slot of said introduction screw;
d. an opening associated with said top portion of said engagement block, said opening defining at least a partial cavity in one of the group consisting of said front face, said back face, and combinations thereof, said opening having a dimension corresponding to a dimension of said elongate finger of said hook; and
e. an elongate securing member comprising at least two about parallel rods, each said rod having a distal end and extending downwardly from at least one of said side portions of said engagement block, said securing member having a closed position wherein a compressive force is applied to a portion of said product disposed between said distal ends of said parallel rods.

38. The clamp of claim 37, said elongate securing member further comprising a handle hingedly engaged with a strap surrounding said rods, said handle having a position corresponding to said closed position of said securing member.

39. The clamp of claim 37, wherein each said distal end of said parallel rods comprise a portion about perpendicular to a main portion of said rod.

40. The clamp of claim 39, wherein each said distal end of said parallel rods comprise one of the group consisting of silicon, rubber, a compressible material, and combinations thereof.

41. The clamp of claim 37, comprising two about parallel rods, wherein said rods are unitarily joined at proximal ends thereof.

42. The clamp of claim 37, said engagement block comprising two side portions, wherein said nipple extends from a first side portion and each said rod extending downwardly from a second side portion.

43. The clamp of claim 37, wherein each said milling, said nipple, and said opening are integrally formed in said engagement block.

44. The clamp of claim 37, wherein said engagement block comprises a substantially T-shape, said top portion having a length less than a length of said milling.

45. The clamp of claim 37, wherein said opening is integrally formed in said top portion of said engagement block, said opening defining a substantially U-shaped channel extending from said front face to said back face.

46. The clamp of claim 45, further comprising at least one cross member disposed at a top of said U-shaped channel.

47. A system for imaging a product temporarily hanging from a clamp, comprising:
a. a rotation block comprising a housing having a top portion fixedly engaged with a conveyor, a spring-loaded locking pin, and a locking trigger fixedly engaged with said locking pin;
b. a gear wheel having a bottom surface operatively engaged with said clamp, a top surface having at least one locking hole for receiving a distal end of said locking pin, and a plurality of teeth at a circumferential edge;
c. a driving member about parallel to an imaging section of said conveyor, said driving member comprising one of the group consisting of a belt, a chain, and combinations thereof, said driving member having a plurality of engaging features on a surface thereof corresponding to said teeth of said gear wheel;
d. a rotation pin axially disposed along a central axis of said gear wheel for rotational coupling of said gear wheel and one of the group consisting of said conveyor, said rotation block, and combinations thereof; and
e. at least one camera proximally disposed to said imaging portion of said conveyor, each camera configured to capture an image of said produce as said produces moves along said conveyor.

48. The system of claim 47, wherein said gear wheel has a fixed position relative to said rotation block when said distal end of said locking pin is engaged in said locking hole.

49. The system of claim 48, wherein said gear wheel rotates around said central axis when said distal end of said locking pin is engaged in said locking hole.

50. The system of claim 49, wherein said gear wheel rotates around said central axis when said engaging features of said driving member are engaged with said teeth of said gear wheel.

51. The system of claim 47, further comprising a plow disposed about parallel to said imaging portion of said conveyor, said plow having a sloped upper surface for slidably contacting a lower surface of said locking trigger.

52. The system of claim 47, comprising N number of cameras, said conveyor moving at a speed of A, said circumferential edge of said gear wheel having a length L.

53. The system of claim 52, said cameras spaced along a length X of said imaging section of said conveyor, each said camera oriented about perpendicularly to a direction of travel of said conveyor.

54. The system of claim 53, said driving member moving at a speed relative to said speed of said conveyor of about L times A divided by X.

55. The system of claim 53, each of said N number of cameras positioned on a single side of said conveyor.

56. The system of claim 52, wherein at least one of said cameras is oriented at an angle of between about 30 and about 150 degrees relative to a direction of travel of said conveyor.

57. The system of claim 56, each of said N number of cameras positioned on a single side of said conveyor.

58. The system of claim 47, said gear wheel rotating between about 180 degrees and about 540 degrees through said imaging section of said conveyor.
